(19) United States
(12) Patent Application Publication
(10) Pub. No.: US 2011/0226995 A1
(43) Pub. Date: Sep. 22, 2011

(54) COMPOSITIONS AND METHODS FOR FUNCTIONALIZING OR CROSSLINKING LIGANDS ON NANOPARTICLE SURFACES

(75) Inventors: Eric Tulsky, Berkeley, CA (US); Wenxi Huang, Eugene, OR (US); James Goodwin, Eugene, OR (US); Weiwen Zhao, Eugene, OR (US)

(73) Assignee: Life Technologies Corporation, Calsbad, CA (US)

(21) Appl. No.: 13/120,335

(22) PCT Filed: Oct. 2, 2009
(86) PCT No.: PCT/US09/59409

§ 371 Date: Jun. 7, 2011

Related U.S. Application Data
(60) Provisional application No. 61/102,666, filed on Oct. 3, 2008.

(51) Int. Cl. C09K 11/02; C08F 8/32; C09K 11/54; C07F 9/50; B82Y 30/00

(52) U.S. Cl. 252/301.36; 525/382; 556/21; 977/773

(57) ABSTRACT

This disclosure provides novel ways to modify/functionalize, including crosslink, ligands in the surface coating or molecules in other coatings on a nanoparticle, by using radical addition reactions to add a reactant group onto a ligand/molecule of a nanoparticle. Examples include using a functionalized benzophenone that can be attached or crosslinked to a ligand in the surface coating of a nanocrystal by photochemically-initiated radical addition.

### CROSS REFERENCE

This application claims benefit of priority to U.S. Provisional Application Ser. No. 61/102,666 filed Oct. 3, 2008, which is hereby incorporated by reference in its entirety.

### TECHNICAL FIELD

This application relates, in part, to nanoparticles and methods of manipulating nanoparticles. In some embodiments, the present application provides novel nanoparticles and compositions thereof. In some embodiments, the present application provides methods for modifying nanoparticles with surface ligands and optional additional coatings. In some embodiments, the present application provides methods for modifying nanoparticles with surface coatings and additional coatings. In some embodiments, the present application provides methods for crosslinking ligands in nanoparticle surface coatings. In some embodiments, the present application provides methods for making stabilized nanoparticles having crosslinked ligands, where crosslinking is achieved by methods that comprise a radical reaction. In some embodiments, the present application provides methods for efficiently functionalizing and/or crosslinking ligands complexed to nanocrystals. In some embodiments, the present application provides methods for crosslinking hydrophobic, hydrophilic, and/or amphiphilic coatings on nanoparticle surfaces, modifying the properties of the nanoparticle surface, and/or providing a functional group with which to attach the nanoparticle to another moiety. In some embodiments, the present application also provides methods for functionalizing molecules (including polymers such as amphiphilic polymers) in an additional coating over the ligand coating of a nanoparticle. In some embodiments, the present application provides methods for crosslinking molecules present in an additional coating on a nanoparticle surface to each other and/or to ligands on the nanoparticle surface coating. The present application further provides stable, functionalized nanoparticles and compositions thereof. The stable, functionalized nanoparticles of the present application and/or compositions comprising thereof can be useful, for example, in numerous detection and biological assays.

### BACKGROUND

Nanoparticles are increasingly important for detecting, tracking, and observing single molecules and microscopic biological structures in a variety of experimental protocols. They provide observable signals that are readily used to locate or track other moieties. Many applications of nanoparticles involve their use in aqueous environments. However, conventional methods for making nanoparticles may produce hydrophobic nanoparticles that are not suitable for use in aqueous media.

Nanoparticles may be hydrophobic when they have a layer of hydrophobic ligands on their surfaces. Methods for modifying the solvent-exposed layer of hydrophobic ligands on a nanoparticle surface to make the nanoparticle hydrophilic, while maintaining its desirable properties as a marker, are needed. Even where hydrophilic or amphiphilic ligands are present on the surface of a nanoparticle, methods for modification of the hydrophilic properties of the nanoparticle (such as increasing hydrophilicity of the nanoparticle surface coating) are desirable. In addition, methods for stabilizing one or more coatings of molecules on a nanoparticle surface are needed.

### SUMMARY

The present application relates, in part, to methods for functionalizing coatings on nanoparticle surfaces. In some embodiments, the methods for functionalizing coatings on nanoparticle surfaces comprise a radical addition reaction.

In some embodiments, the methods for functionalizing ligands on nanoparticle surfaces comprises introducing onto a ligand on a nanoparticle surface a functional group capable of generating a radical species. In some embodiments, the present application provides methods for crosslinking ligands and other coatings on nanoparticle surfaces. In some embodiments, the present application provides methods for making stabilized nanoparticles having crosslinked ligands, where crosslinking is achieved by methods that comprise a radical reaction. In some embodiments, the present application provides methods for efficiently functionalizing and/or crosslinking ligands and other coatings complexed to nanocrystals or nanoparticles. In some embodiments, the present application provides methods for crosslinking hydrophobic, hydrophilic, and/or amphiphilic coatings on nanoparticle surfaces, modifying the properties of nanoparticles, and/or providing a functional group with which to attach the nanoparticle to another moiety. The present application further provides stable, functionalized nanoparticles and compositions thereof. The stable, functionalized nanoparticles of the present application and/or compositions comprising thereof can be useful, for example, in numerous detection and biological assays.

The present application further provides stable, functionalized nanoparticles. The stable, functionalized nanoparticles of the present application and/or compositions thereof can be useful in numerous detection and biological assays. The compositions and methods of the present application can be used to make stabilized nanoparticles having crosslinked ligands and other coatings, where crosslinking is achieved by methods that comprise a radical reaction. The novel methods of this disclosure enable efficient functionalizing or crosslinking of ligands complexed to nanocrystals or nanoparticles, and can also be used to crosslink other hydrophobic or hydrophilic coatings, to modify the properties of the nanoparticle, or to provide a functional group with which to attach the nanoparticle to another moiety.

Provided herein are methods to crosslink molecular compounds that are suitable for coating a nanocrystal surface, to alter the chemical stability and photostability of the nanocrystal-ligand complexes. The methods also provide ways to modify and stabilize the surface structure and properties of a nanoparticle, and provide novel compositions comprising a nanocrystal coated with cross-linked molecules. The methods of this disclosure can be applied to hydrophilic, hydrophobic, and amphiphilic nanocrystal coatings, and are suitable for crosslinking molecules already complexed to a nanocrystal.

In one aspect, provided herein are methods for crosslinking ligands that may be present on the inorganic surface of a nanocrystal. The methods of this disclosure are generally applicable to many types of ligands, and may be advantageous over conventional crosslinking methods for a number of reasons, e.g., because they can be applied to nanocrystals that have no or too few functionalized ligands on their surfaces to be effectively crosslinked by conventional methods and reagents, or because they provide chemoselectivity for crosslinking in the presence of other functional groups. The methods disclosed herein can also be used in combination with known methods for crosslinking ligands on the surfaces of nanocrystals to increase both versatility and effectiveness of crosslinking such ligands.

In some aspects, this application provides methods for stabilizing a ligand-coated nanoparticle by crosslinking ligands on the surface of the nanocrystal. The methods involve radical addition reactions to introduce functionality into ligands on a nanocrystal surface, or to provide crosslinking. The nanoparticle may be a nanocrystal, typically a core/shell semiconductor nanocrystal, which is coated with a layer of ligands. The ligands may be hydrophobic or hydrophilic, or a mixture thereof. They may comprise one or more alkyl groups, which can be straight chain, branched, cyclic, or a combination of these, and these alkyl groups can comprise from 1 to 40 carbon atoms per ligand. Suitable ligands include organic compounds that comprise at least one functional group selected from phosphine, phosphine oxide, phosphonic acid, phosphinic acid, carboxylate, amine, thiol, thiocarboxylate, dithiocarbamate and imidazole, each of which is suitable for coordinating to the surface of some types of nanocrystals. Optionally, the ligand can comprise a plurality of these functional groups.

Suitable radical addition reactions for certain embodiments of the disclosed methods and compositions include those that are compatible with the functionality present on the nanocrystal of interest, and that introduce a new functional group or reactive group on an atom of a ligand on a nanocrystal surface, for example, attached to a carbon atom. The new functional group or reactive group can be, for example, a halide, amine, hydroxyl, alkoxy, or other group added onto a ligand via a radical addition mechanism. Specific examples of suitable radical addition reactions are disclosed herein. The functionality introduced by the radical addition reaction is useful to crosslink the ligands on the nanocrystal.

Crosslinking methods as described herein are generally achieved in two steps, and such methods typically utilize a radical reaction as one of the two steps. The radical reaction can be the first step, where the radical reaction can be initiated by any suitable means; in some embodiments, it is initiated photochemically.

In some respects, this disclosure provides a nanoparticle composition having a substituted benzophenone adduct that is useful to crosslink two or more ligands on the surface of the nanocrystal. The substituted benzophenone adduct may be the product of photochemical attachment of a ketyl radical of a substituted benzophenone to a first ligand on the nanocrystal surface. The first ligand may be any organic group or molecule that is attached to the nanocrystal inorganic surface.

Once attached to the surface of a nanocrystal, the substituted benzophenone adduct may participate in an additional covalent bond-forming reaction between a substituent on the benzophenone and a different or second ligand on the nanocrystal surface. The substituted benzophenone may therefore be linked to two or more different ligands present on the surface of a nanocrystal, tying or crosslinking the ligands together.

A plurality of substituted benzophenone adducts may be formed on the surface of the nanocrystal, leading to efficient and extensive crosslinking of the nanocrystal surface ligands. These crosslinked ligands render the nanocrystal more stable, and protect it from chemical degradation and from loss of its luminescent or fluorescent properties.

Further, the substituted benzophenone adducts provide a reactive substituent group on the surface of the nanocrystal, thereby functionalizing the nanocrystal so it can be made more water-soluble or for attachment to biomolecules or other moieties.

The ligands on the nanocrystal surface to which the substituted benzophenone is attached by radical addition may be organic molecules having one or more nanocrystal-binding groups which are attached to the nanocrystal inorganic surface and having at least one alkyl portion having one or more C—H bonds. The alkyl portion can be straight chain, branched or cyclic, or a combination of these. The alkyl portion may arise from, e.g., tri-n-octyl phosphine oxide (TOPO), tri-n-octyl phosphine (TOP), tetradecylphosphonic acid (TDPA), or oleic acid as surface ligands.

In some embodiments, a substituted benzophenone can provide efficient crosslinking of a multicomponent nanoparticle surface. For example, Adams et al. U.S. Pat. No. 6,649,138 describe a nanoparticle having an amphiphilic layer/coating formed by one or more amphiphilic polymers (AMP) which coats over an organic surface coating/layer comprising surface ligands that are coordinated directly to the nanocrystal inorganic surface. The layer of organic surface ligands may arise from, e.g., TOPO, TOP, TDPA, or oleic acid used in the synthesis of the nanocrystal. The AMP is a low-dispersity polyacrylic acid-based polymer with some of its carboxylic acids converted into amides, as well as substituted with medium- to long-chain alkyl groups. In a multicomponent nanocrystal surface, AMP molecules can coat the surface ligand alkyl groups. Some of the carboxylic acids of the AMP provide water solubility on the outer water-facing particle surface, while a stabilizing interior hydrophobic zone is formed by the medium- or long-chain alkyl groups of the AMP interacting via hydrophobic-hydrophobic interactions with alkyl groups belonging to ligands present on the surface of a nanocrystal. In these embodiments, substituted benzophenone adducts may be formed with alkyl groups of a ligand of the surface coating, and the reactive substituent of the substituted benzophenone may be crosslinked with a carboxylic acid group of an AMP, thereby strongly linking the AMP layer to the surface ligand layer of the nanocrystal. For example, a reactive amino group of the substituted benzophenone may be crosslinked with a carboxylic acid group of the AMP. In some embodiments, substituted benzophenone adducts may be formed with a moiety of an AMP molecule in the AMP coating, and the reactive/photoreactive substituent of the substituted benzophenone may be crosslinked to another AMP, a surface coordinated ligand, or both. For example, a reactive amino group of the substituted benzophenone may be crosslinked with a carboxylic acid group of another AMP.

In some embodiments, provided herein are compositions and methods for stabilizing a ligand-coated nanoparticle by crosslinking the ligands on the surface of the nanocrystal, or stabilizing a nanoparticle that has a surface coating comprising ligands and an additional coating comprising polymer molecules (the polymer molecules are connected to the surface ligands) by providing chemical linkages (covalent bonds) connecting the polymer molecules to the ligands on the nanocrystal or connecting the polymer molecules to each other. In some embodiments, a radical addition reaction uses a bifunctional compound to form one bond to a ligand by a radical reaction induced by irradiation (photoinitiated reaction), and the bifunctional compound forms another bond with a ligand or another polymer molecule by a non-radical reaction. The two reactions can link ligands to each other, they can link a polymer to a ligand, or they can link two polymers together. These methods involve a radical addition reaction to modify and stabilize a ligand-coated nanocrystal by crosslinking ligands on the nanocrystal, or by linking a polymer to the ligands on the nanocrystal. The methods can also be used to link other polymer molecules to the nanocrystal by linking the polymer molecules to a ligand on the nanocrystal surface. The methods can also be used to link together polymer molecules that are associated with ligands on a nanocrystal to form a cross-linked layer of polymer molecules that is stably associated or complexed with the nanocrystal ligands, thus forming a stabilized nanoparticle that includes the polymer molecules.

The polymers used herein may have two or more types of reactive groups, one of which is photoreactive and upon irradiation undergoes radical addition with a C—H bond present in a coating on the surface of the nanoparticle or nanocrystal. A second type of reactive functional group of the polymer may be hydrophilic and/or participate in solubilization, conjugation, or derivatization of the nanoparticle surface. The polymer can be linear, branched, multiple-branched or dendridic; suitable polymer molecules are further described herein. The polymer may be amphiphilic, having a plurality of hydrophobic photoreactive groups substituted in some portions of its structure and a plurality of hydrophilic reactive functional groups substituted in other portions of its structure. Methods for stabilizing a coated nanoparticle include self-assembly of the photoreactive polymer on to the surface of the coated nanoparticle and photolysis of the assembled nanoparticle. An example of a suitable photoreactive polymer for such methods is an AMP having one or more substituted benzophenones attached to it. For example, an AMP can be covalently linked to one or more aminobenzophenones by forming amide bonds between an amino group of an aminobenzophenone and a carboxyl group of the AMP. When such a photoreactive polymer associates with ligands on a nanocrystal, photochemical reaction of the benzophenone moiety with alkyl groups of the ligands on the nanocrystal can be used to link the AMP molecules to the ligands (and optionally also to link the AMP molecules to neighboring AMP molecules), providing a stabilized nanoparticle.

Other aspects and advantages of the disclosure will be apparent from the more detailed description below, by reference to certain embodiments thereof, and in further view of the examples included herein. It is to be understood that the terminology used herein is for the purpose of describing specific embodiments only and is not intended to be limiting.

### BRIEF DESCRIPTION OF DRAWINGS

For a fuller understanding of the nature and advantages of the embodiments disclosed herein, reference should be made to the following detailed description taken in connection with the accompanying drawings, in which:

FIG. 1 shows how an aminobenzophenone (or an aminoalkylbenzophenone) 1-1 can be linked covalently to an existing functionalized ligand having a carboxyl group on nanoparticle 1-3, through a nonradical reaction (e.g. a coupling reaction to form an amide/peptide bond) to result in a new ligand, to which the aminobenzophenone or an aminoalkylbenzophenone is attached. The new ligand can be photolyzed to crosslink to another ligand that has an alkyl group (and thus to afford nanoparticle 1-7). FIG. 1 also illustrates how the aminobenzophenone (or an aminoalkylbenzophenone) 1-1 can be used to functionalize a ligand that has an alkyl group on nanocrystal 1-3, through a radical reaction. The functionalized ligand on benzophenone adduct 1-6 (having an amino group) can be further crosslinked to another ligand, thus forming nanoparticle 1-7 by means of a different route. For example, when the other ligand has a carboxyl group, an aminde/peptide bond formation reaction (a nonradical reaction) can be used for the crosslinking. The reaction of the amino group to a carboxyl group can also be referred as acylation of the amino group. The shaded sphere represents a nanocrystal or nanoparticle, and the lines from it represent ligands or portions of ligands that are connected to the nanocrystal or nanoparticle. The straight lines extending from the nanocrystal or nanoparticle are not intended to denote explicit chemical bonds, but merely denote an unspecified portion of a ligand. Each of l, m, and n can be, for example, 0, 1, 2, 3, 4, 5, 6, 7, 8, 9, or 10. R can be, for example, H, NH₂, CH₂NH₂, or COOH.

FIG. 2 shows how a ligand having an aminobenzophenone adduct on nanoparticle 2-1 (which can be formed by the method for functionalizing ligands described in FIG. 1 that results in nanoparticle 1-6) can be crosslinked to another ligand that also has an amino group, by using a crosslinking reagent for example, tris(hydroxymethyl)phosphine (THP), and thus to afford nanoparticle 2-3 [intermediate nanoparticle 2-2 is also shown]. Note that the amino group on the other ligand could be an amino provided by another aminobenzophenone adduct. If the nanoparticle 1-1 of FIG. 1 has two ligands each of which has an alkyl group, the method for functionalizing ligand described in FIG. 1 (to form the functionalized ligand on nanoparticle 1-6) can be used to functionalize both ligands, and thus to provide two ligands each of which has an aminobenzophenone adduct. Each of l, m, and n can be, for example, 0, 1, 2, 3, 4, 5, 6, 7, 8, 9, or 10.

FIG. 3 shows other ways to functionalize ligands that have an alkyl groups. Bromination using NBS provides a bromo group on an alkyl group on a ligand. The bromo group can undergo further chemical modification such as being converted to an azide or an amino group. FIG. 3 also shows other ways to crosslink two functionalized ligands by using alkylation (e.g. using Cys-Cys to crosslink two ligands each of which has a bromo group), cycloaddition (e.g. using a compound that has two —C≡CH (alkynyl functions) to crosslink two ligands each of which has an azide group), or other known reactions (for example, using THP to crosslink two ligands each of which has an amino group). Each of m1, n1, m2, and n2 can be, for example, 0, 1, 2, 3, 4, 5, 6, 7, 8, 9, or 10.

FIG. 4 shows the quantum yield upon exposure to UV light of a crosslinked coated nanoparticle prepared with a core/shell CdSe/ZnS nanocrystal QDOT™ 655 and polyacrylic acid in which some of the carboxylic acid groups have been coupled with octylamine and 4-aminobenzophenone. The quantum yield of the photolyzed nanoparticle increased significantly under UV exposure for about twenty to forty minutes.

FIG. 5 shows schematically how an amphiphilic polymer (AMP) derivatized with a photoactivatible crosslinker (e.g. one or more bifunctional molecules are attached to an AMP) can coat the surface of the nanoparticle in a process utilizing hydrophobic-hydrophobic interactions with the hydrophobic ligands directly bound to the inorganic surface, followed by photolysis, which results in photoactivation of the photoactivatible crosslinker and formation of several possible types of stabilizing crosslinks on the nanoparticle surface. Immobilization of the photoreactivatible group of the bifunctional crosslinker within the hydrophobic zone resulting from the self-assembly process results in efficient crosslinking due to the high effective concentration of nearby H-abstraction targets as well as sequestration of the photogenerated reactive moiety away from non-productive events the tend to occur more often in water.

### DETAILED DESCRIPTION

Embodiments disclosed herein may be understood more readily by reference to the following detailed description and Examples. It is to be understood that the terminology used is for the purpose of describing specific embodiments only and is not intended to be limiting.

Unless defined otherwise, all technical and scientific terms have the same meaning as is commonly understood by one of ordinary skill in the art to which the embodiments disclosed belongs.

As used herein, “a” or “an” means “at least one” or “one or more.”

As used herein, “about” means that the numerical value is approximate and small variations would not significantly affect the practice of the disclosed embodiments. Where a numerical limitation is used, unless indicated otherwise by the context, “about” means the numerical value can vary by ±10% and remain within the scope of the disclosed embodiments.

The term “alkenyl” is used herein to mean a straight or branched chain radical of 2-20 carbon atoms, unless the chain length is otherwise limited, wherein there is at least one double bond between two of the carbon atoms in the chain, including, but not limited to, ethenyl, 1-propenyl, 2-propenyl, 2-methyl-1-propenyl, 1-butenyl, 2-butenyl, and the like. Preferably, the alkenyl chain is 2 to 8 carbon atoms in length, most preferably from 2 to 4 carbon atoms in length.

The term “alkyl” as employed herein by itself or as part of another group refers to both straight and branched chain radicals of up to 20 carbons, unless the chain length is otherwise limited, such as methyl, ethyl, propyl, isopropyl, butyl, s-butyl, t-butyl, isobutyl, pentyl, hexyl, isohexyl, heptyl, 4,4-dimethylpentyl, octyl, 2,2,4-trimethylpentyl, nonyl, or decyl.

The term “alkynyl” is used herein to mean a straight or branched chain radical of 2-20 carbon atoms, unless the chain length is otherwise limited, wherein there is at least one triple bond between two of the carbon atoms in the chain, including, but not limited to, ethynyl, 1-propynyl, 2-propynyl, and the like. Preferably, the alkynyl chain is 2 to 8 carbon atoms in length, most preferably from 2 to 4 carbon atoms in length.

In all instances herein where there is an alkenyl or alkynyl moiety as a substituent group, the unsaturated linkage, i.e., the vinyl or ethenyl linkage, is preferably not directly attached to a nitrogen, oxygen or sulfur moiety.

The term “alkoxy” or “alkyloxy” refers to any of the above alkyl groups linked to an oxygen atom. Typical examples are methoxy, ethoxy, isopropyloxy, sec-butyloxy, and t-butyloxy.

The term “aralkyl” or “arylalkyl” as employed herein by itself or as part of another group refers to C₁₋₆ alkyl groups as discussed above having an aryl substituent, such as benzyl, phenylethyl or 2-naphthylmethyl.

The term “aryl” as employed herein by itself or as part of another group refers to monocyclic or bicyclic aromatic groups containing from 6 to 12 carbons in the ring portion, preferably 6-10 carbons in the ring portion. Typical examples include phenyl, biphenyl, naphthyl or tetrahydronaphthyl.

The terms “attached” or “operably bound” as used herein interchangeably to refer to formation of a covalent bond or a non-covalent association between a combination of two or more molecules, of sufficient stability for the purposes of use in detection systems as described herein and standard conditions associated therewith as known in the art. The attachment may comprise, but is not limited to, one or more of a covalent bond, an ionic bond, a hydrogen bond, or a van der Waals interaction.

The term “coating” as employed herein refers to the portions of the nanoparticle that are not the inorganic parts, excluding any biologically derived cargo moieties that may also be present and associated with the nanoparticle for purposes directly related to detection and biological assays. In some instances, a coating can comprise a small molecule ligand directly bound to the inorganic core or shell via covalent or coordinate covalent bonding. In other instances, a coating can comprise an amphiphilic polymer that associates stably with the nanoparticle by means of hydrophobic:hydrophobic interactions with ligands that are themselves directly bound to the inorganic core or shell via covalent or coordinate covalent bonding. In some instances, a coating can comprise a combination of one or more types of small molecule ligands and one or more types of amphiphilic polymers associated with the nanocrystal by any of the above means.

The term “carboxyalkyl” as employed herein refers to any of the above alkyl groups wherein one or more hydrogens thereof are substituted by one or more carboxylic acid moieties.

A “nanocrystal core” is understood to mean a nanocrystal to which no shell has been applied; typically it is a semiconductor nanocrystal. A nanocrystal core can have a homogenous composition or its composition can vary with depth inside the nanocrystal. Many types of nanocrystals are known, and methods for making a nanocrystal core and applying a shell to a nanocrystal core are known in the art. The shell-forming methods described herein are applicable for producing a shell on nanocrystal cores. To distinguish a nanocrystal used in disclosed embodiments from one that might be formed unintentionally in a shell-forming step, the nanocrystal introduced into a reaction mixture is referred to as a primary nanocrystal, regardless of whether it is a nanocrystal core or a core/shell nanocrystal. In either event, the methods disclosed herein produce a new shell on the surface of the primary nanocrystal.

As used in the claims and specification, the words “comprising” (and any form of comprising, such as “comprise” and “comprises and “comprised”), “having” (and any form of having, such as “have” and “has”), “including” (and any form of including, such as “includes” and “include”), or “containing” (and any form of containing, such as “contains” and “contain”), are inclusive or open-ended and do not exclude additional, unrecited elements or method steps.

The term “cycloalkyl” as employed herein by itself or as part of another group refers to cycloalkyl groups containing 3 to 9 carbon atoms. Typical examples are cyclopropyl, cyclobutyl, cyclopentyl, cyclohexyl, cycloheptyl, cyclooctyl and cyclononyl.

The term “cycloalkylalkyl” or “cycloalkyl(alkyl)” as employed herein, by itself or as part of another group, refers to a cycloalkyl group attached to an alkyl group. Typical examples are 2-cyclopentylethyl, cyclohexylmethyl, cyclopentylmethyl, 3-cyclohexyl-n-propyl, and 5-cyclobutyl-n-pentyl.

The term “cycloalkenyl” as employed herein, by itself or as part of another group, refers to cycloalkenyl groups containing 3 to 9 carbon atoms and 1 to 3 carbon-carbon double bonds. Typical examples include cyclopropenyl, cyclobutenyl, cyclopentenyl, cyclohexenyl, cyclohexadienyl, cycloheptenyl, cycloheptadienyl, cyclooctenyl, cyclooctadienyl, cyclooctatrienyl, cyclononenyl, and cyclononadienyl.

The term “dialkylamine” or “dialkylamino” as employed herein by itself or as part of another group refers to the group NH₂ wherein both hydrogens have been replaced by alkyl groups, as defined above.

The term “haloalkyl” as employed herein refers to any of the above alkyl groups wherein one or more hydrogens thereof are substituted by one or more halo moieties. Typical examples include fluoromethyl, difluoromethyl, trifluoromethyl, trichloroethyl, trifluoroethyl, fluoropropyl, and bromobutyl.

The term “halogen” or “halo” as employed herein by itself or as part of another group refers to chlorine, bromine, fluorine or iodine.

The term “heterocycle” may refer to a “heteroaryl.” “Heteroaryl” as employed herein refers to groups having 5 to 14 ring atoms; 6, 10 or 14 pi electrons shared in a cyclic array; and containing carbon atoms and 1, 2, 3, or 4 oxygen, nitrogen or sulfur heteroatoms (where examples of heteroaryl groups are: thienyl, benzo[b]thienyl, naphtho[2,3-b]thienyl, thianthrenyl, furyl, pyranyl, isobenzofuranyl, benzoxazolyl, chromenyl, xanthenyl, phenoxathiinyl, 2H-pyrrolyl, pyrrolyl, imidazolyl, pyrazolyl, pyridyl, pyrazinyl, pyrimidinyl, pyridazinyl, indolizinyl, isoindolyl, 3H-indolyl, indolyl, indazolyl, purinyl, 4H-quinolizinyl, isoquinolyl, quinolyl, phthalazinyl, naphthyridinyl, quinazolinyl, cinnolinyl, pteridinyl, 4αH-carbazolyl, carbazolyl, β-carbolinyl, phenanthridinyl, acridinyl, perimidinyl, phenanthrolinyl, phenazinyl, isothiazolyl, phenothiazinyl, isoxazolyl, furazanyl, phenoxazinyl, and tetrazolyl groups).

The terms “heteroarylalkyl” or “heteroaralkyl” as employed herein both refer to a heteroaryl group attached to an alkyl group. Typical examples include 2-(3-pyridyl)ethyl, 3-(2-furyl)-n-propyl, 3-(3-thienyl)-n-propyl, and 4-(1-isoquinolinyl)-n-butyl.

The term “heteroatom” is used herein to mean an oxygen atom (“O”), a sulfur atom (“S”) or a nitrogen atom (“N”). It will be recognized that when the heteroatom is nitrogen, it may form an NR^{a}R^{b} moiety, wherein R^{a} and R^{b} are, independently from one another, hydrogen or C₁ to C₈ alkyl, or together with the nitrogen to which they are bound form a saturated or unsaturated 5-, 6-, or 7-membered ring.

The term “heterocycle” may also refer to a “heterocycloalkyl” or “heterocyclic.” “Heterocycloalkyl” or “heterocyclic” as used herein may refer to any saturated or partially unsaturated heterocycle. By itself or as part of another group, “heterocycle” or “heterocyclic” may refer to a saturated or partially unsaturated ring system having 5 to 14 ring atoms selected from carbon atoms and 1, 2, 3, or 4 oxygen, nitrogen, or sulfur heteroatoms. Typical saturated examples include pyrrolidinyl, imidazolidinyl, pyrazolidinyl, tetrahydrofuranyl, tetrahydropyranyl, piperidyl, piperazinyl, quinuclidinyl, morpholinyl, and dioxacyclohexyl. Typical partially unsaturated examples include pyrrolinyl, imidazolinyl, pyrazolinyl, dihydropyridinyl, tetrahydropyridinyl, and dihydropyranyl. Either of these systems can be fused to a benzene ring. When a substituent is oxo (i.e., ═O), then 2 hydrogens on the atom are replaced. When aromatic moieties are substituted by an oxo group, the aromatic ring is replaced by the corresponding partially unsaturated ring. For example a pyridyl group substituted by oxo results in a pyridone.

The terms “hydroxyl” and “hydroxy” are used interchangeably to refer to the radical —OH.

The term “hydroxyalkyl” as employed herein refers to any of the above alkyl groups wherein one or more hydrogens thereof are substituted by one or more hydroxyl moieties.

The term “inorganic surface” refers to the outer inorganic boundary of the inorganic nanocrystal core or inorganic shell that overlays the nanocrystalline core. “Ligands” and “coatings”, as defined herein, refer to additional modifications that exist or can be applied onto the inorganic surface.

The term “ligand” as used herein refers to a molecular species chemically bound via direct covalent or coordinate covalent bonding to the inorganic surface of the nanocrystal core or shell of a nanocrystal.

The terms “luminescence” and “fluorescence” as used herein, have one and the same meaning. The terms “luminescent” and “fluorescent” as used herein, have one and the same meaning.

The term “monoalkylamine” or “monoalkylamino” as employed herein by itself or as part of another group refers to the group NH₂ wherein one hydrogen has been replaced by an alkyl group, as defined above.

“Monodisperse” as used herein refers to a population of particles (e.g., a colloidal system) wherein the particles have substantially identical size and shape. For the purpose of the present disclosure, a “monodisperse” population of particles means that at least about 60% of the particles, preferably about 75% to about 90% of the particles, fall within a specified particle size range. A population of monodisperse particles deviates less than 10% rms (root-mean-square) in diameter, and preferably deviates less than 5% rms.

“Nanocrystal” as used herein can refer to a nanoparticle made out of an inorganic substance that typically has an ordered crystalline structure having at least one major dimension in the nanosize range. Typically, a nanocrystal can have at least one major dimension ranging from about 1 to 1000 nm. It can refer to a nanocrystal having a crystalline core (core nanocrystal), or to a core/shell nanocrystal. Typically, a nanocrystal has a core diameter ranging from 1 to 100 nm, and in some embodiments, between about 1 to 50 nm.

“Nanoparticle” as used herein refers to any nanocrystal, such as a core or core/shell nanocrystal, which may optionally further have a surface coating of ligands or other materials that can be on the surface of the nanocrystal. A nanoparticle can also include a core/shell nanocrystal, as well as a core nanocrystal or a core/shell nanocrystal having a layer of, for example, TDPA, OPA, TOP, TOPO or other material that is not removed from the surface by ordinary solvation. A nanoparticle can have a layer of ligands on its surface which can further be cross-linked; a nanoparticle can have other or additional coatings (in addition to the ligand coating) that can modify the properties of the particle, for example, increasing or decreasing solubility in water or other solvents. Such layers/coatings on the surface are included in the term ‘nanoparticle.’

“Optional” or “optionally” may be taken to mean that the subsequently described structure, event or circumstance may or may not occur, and that the description includes instances where the event occurs and instances where it does not.

The phrase “optionally substituted” when not explicitly defined refers to a group or groups being optionally substituted with one or more substituents independently selected from the group consisting of hydroxy, nitro, trifluoromethyl, halogen, C₁₋₆ alkyl, C₁₋₆ haloalkyl, C₁₋₆ alkoxy, C₁₋₆ alkylenedioxy, C₁₋₆ aminoalkyl, C₁₋₆hydroxyalkyl, C₂₋₄ alkenyl, C₂₋₄ alkynyl, C₆₋₁₀ aryl, phenoxy, benzyloxy, 5-10 membered heteroaryl, C₁₋₆ aminoalkoxy, amino, mono(C₁₋₄)alkylamino, di(C₁₋₄)alkylamino, C₂₋₆ alkylcarbonylamino, C₂₋₆ alkoxycarbonylamino, C₂₋₆ alkoxycarbonyl, C₂₋₆ alkoxycarbonylalkyl, carboxy, C₂₋₆ hydroxyalkoxy, (C₁₋₆)alkoxy(C₂₋₆)alkoxy, mono(C₁₋₄)alkylamino(C₂₋₆)alkoxy, di(C₁₋₄)alkylamino(C₂₋₆)alkoxy C₂₋₁₀ mono(carboxyalkyl)amino, bis(C₂₋₁₀ carboxyalkyl)amino, C₂₋₆ carboxyalkoxy, C₂₋₆ carboxyalkyl, carboxyalkylamino, guanidinoalkyl, hydroxyguanidinoalkyl, cyano, trifluoromethoxy, perfluoroethoxy, aminocarbonylamino, mono(C₁₋₄)alkylaminocarbonylamino, di(C₁₋₄)alkylaminocarbonylamino, N-(C₁₋₄)alkyl-N-aminocarbonyl-amino, N-(C₁₋₄)alkyl-N-mono(C₁₋₄)alkylaminocarbonyl-amino or N-(C₁₋₄)alkyl-N-di(C₁₋₄)alkylaminocarbonyl-amino.

“Surface layer” or “surface coating” as used herein refers to a layer of molecules coordinatively associated with the nanocrystal or, in some cases, an additional water-facing outer polymer coating associated hydrophobically with the directly coordinated hydrophobic ligands residing on the nanocrystal inorganic surface, any or all of which may be further crosslinked or modified as explained herein. For example, the surface layer may be modified to deprotect or unmask functional groups present on the ligand, using conditions known to those of skill in the art. As used herein, a ligand refers to a molecule that is coordinated to a nanocrystal's inorganic surface. A nanoparticle may have other or additional coatings that modify the solubility properties of the particle, which are sometimes referred to herein as “coating layers” or “capping layers” or “coatings.” The surface layer/coating (or an outer coating over the ligand layer of a nanoparticle, if present) may also be operably bound to a cargo molecule, such as, for example, an antibody, polynucleotide, or other biomolecule.

Any functional group known in the art may be utilized as a functional group in various embodiments. Therefore, nanoparticles having a wide variety of surface functionalities may be produced. For example, in some embodiments, the functional groups may be halogens, amino, hydroxyl, or substituted alkoxy, acyl, or benzophenone moieties. In some embodiments, the functional groups can be useful in increasing hydrophilicity of the nanoparticles. The functional groups can also be groups useful for crosslinking the functionalized ligands to other moieties on the same nanoparticle (for example, two functionalized ligands formed by the methods provided here can be crosslinked, or a functionalized ligand formed by the methods provided here can be crosslinked to another pre-existing functionalized ligand). In some embodiments, a functional group is a reactive functional group, which can be used to react with another moiety.

In some embodiments, a nanoparticle comprises a nanocrystal and a surface coating (such as molecule ligands) coordinated to the nanocrystal's inorganic surface. In such embodiments, a ligand of the surface coating is connected to the nanocrystal. In some embodiments, a nanoparticle comprises a nanocrystal, a surface coating of ligands coordinated to the nanocrystal's inorganic surface (such as an organic small molecule surface coating), and an additional coating of polymer molecules connected to the surface ligand coating. In such embodiments, a polymer in the additional polymer coating is connected to the nanocrystal surface layer through, for example, hydrophobic-hydrophobic interactions.

The nanocrystals used in embodiments are generally bright fluorescent nanocrystals, and the nanoparticles prepared from them are typically also bright having, for example, a quantum yield of at least about 10%, sometimes at least 20%, sometimes at least 30%, sometimes at least 40%, and sometimes at least 50% or greater. In some embodiments, nanocrystals can have a surface layer of ligands to protect them from degradation during use or while in storage; thus isolated nanocrystals made by the methods of embodiments can have a surface layer of ligands on the outside of the shell of the nanocrystal.

“Quantum dot” as used herein typically refers to a nanocrystalline particle made from a material that in the bulk is a semiconductor or insulating material, which has tunable photophysical properties in the near ultraviolet (UV) to far infrared (IR) range.

The term “water-soluble” is used herein to mean the item can be soluble or stably suspendable in an aqueous-based solution, such as in water or water-based solutions or buffer solutions, including those used in biological or molecular detection systems as known by those skilled in the art. While water-soluble nanoparticles are not truly ‘dissolved’ in the sense that term is used to describe individually solvated small molecules, they are solvated and suspended in solvents that are compatible with their outer surface layer; thus a nanoparticle that is readily dispersed in water is considered water-soluble or water-dispersible. The term water-dispersible can therefore also be used to describe this property. A water-soluble or water-dispersible nanoparticle can also be considered hydrophilic when its surface is compatible with water and with water solubility.

The term “hydrophobic nanoparticle” as used herein can refer to a nanoparticle that can be readily dispersed in or dissolved in a water-immiscible solvent such as, for example, hexanes, toluene, and the like. Such nanoparticles are generally not readily dispersible in water.

Nanoparticles can be synthesized in shapes of different complexity such as spheres, rods, discs, triangles, nanorings, nanoshells, tetrapods, nanowires and so on. Each of these geometries has distinctive properties: spatial distribution of surface charge, orientation dependence of polarization of an incident light wave, and spatial extent of the electric field of the particle. In some embodiments, the nanocrystals are roughly spherical.

In some embodiments, a nanoparticle may be a core/shell nanocrystal having a nanocrystal core covered by a semiconductor shell. The thickness of the shell can be adapted to provide desired particle properties. The thickness of the shell may affect fluorescence wavelength, quantum yield, fluorescence stability, and other photophysical characteristics.

The nanocrystal core and shell can be made of any suitable metal and non-metal atoms that are known to form semiconductor nanocrystals. Suitable semiconductor materials for the core and/or shell include, but are not limited to, ones including Group 2-16, 12-16, 13-15 and 14 element-based semiconductors such as ZnS, ZnSe, ZnTe, CdS, CdSe, CdTe, HgS, HgSe, HgTe, MgS, MgSe, MgTe, CaS, CaSe, CaTe, SrS, SrSe, SrTe, BaS, BaSe, BaTe, GaN, GaP, GaAs, GaSb, InP, InAs, InSb, AlS, AlP, AlSb, PbS, PbSe, Ge and Si and ternary and quaternary mixtures thereof. Typically, the core and the shell of a core/shell nanocrystal are composed of different semiconductor materials, meaning that at least one atom type of a binary semiconductor material of the core of a core/shell is different from the atom types in the shell of the core/shell nanocrystal.

Nanocrystals can be characterized by their percent quantum yield of emitted light. For example, the quantum yield can be greater than about 10%, greater than about 20%, greater than about 30%, greater than about 40%, greater than about 50%, greater than about 60%, greater than about 70%, greater than about 80%, greater than about 90%, and ranges between any two of these values. The quantum yield is typically greater than about 30%, and preferably greater than 50% or greater than 70%.

The nanocrystal can be of any suitable size; typically, it is sized to provide fluorescence emission in the UV-visible portion of the electromagnetic spectrum, since this range is convenient for use in monitoring biological and biochemical events in relevant media. The relationship between size and fluorescence emission wavelength is well known, thus, making nanoparticles that emit at a shorter wavelength may require selecting a particular material that gives a suitable wavelength at a small size, such as ZnTe as the core of a core/shell nanocrystal designed to be especially small. In frequent embodiments, the nanocrystals described herein are from about 1 nm to about 100 nm in diameter, sometimes from about 1 to about 50 nm in diameter, and sometimes from about 1 to about 25 nm in diameter. For a nanocrystal that is not substantially spherical, e.g. rod-shaped, it may be from about 1 to about 100 nm, or from about 1 nm to about 50 nm or 1 nm to about 25 nm in its smallest dimension.

Generally, a nanocrystal is a semiconductor particle, having a diameter or largest dimension in the range of about 1 nm to about 100 nm, or in the range of about 2 nm to about 50 nm, and in certain embodiments, in the range of about 2 nm to about 20 nm or from about 2 to about 10 nm. More specific ranges of sizes include about 0.5 nm to about 5 nm, about 1 nm to about 50 nm, and about 1 nm to about 20 nm. Specific size examples include about 0.1 nm, about 0.5 nm, about 1 nm, about 2 nm, about 3 nm, about 4 nm, about 5 nm, about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, about 20 nm, about 25 nm, about 30 nm, about 35 nm, about 40 nm, about 45 nm, about 50 nm, and ranges between any two of these values.

In some embodiments, a nanocrystal core is less than about 10 nm in diameter, or less than about 7 nm in diameter, or less than about 5 nm in diameter. The small size of these nanocrystals is advantageous in many applications, particularly because the nanocrystals of some embodiments are surprisingly bright for their size.

A typical single-color preparation of nanoparticles has nanocrystals that are preferably of substantially identical size and shape. Nanocrystals are typically thought of as being spherical or nearly spherical in shape, but can actually assume many shapes, e.g., nanocrystals can be non-spherical in shape. For example, the nanocrystal's shape can change towards oblate spheroids for redder colors. It is preferred that at least about 60%, at least about 70%, at least about 80%, at least about 90%, at least about 95%, and ideally about 100% of the particles are of the same size and shape. Size deviation can be measured as the root mean square (“rms”) of the diameter, with less than about 30% rms, preferably less than about 20% rms, more preferably less than about 10% rms. Size deviation can be less than about 10% rms, less than about 9% rms, less than about 8% rms, less than about 7% rms, less than about 6% rms, less than about 5% rms, or ranges between any two of these values. Such a collection of particles is sometimes referred to as being “monodisperse.” One of ordinary skill in the art will realize that particular preparations of nanocrystals, such as of semiconductor nanocrystals, are actually obtained as particle size distributions.

It is well known that the color (emitted light) of a semiconductor nanocrystal can be “tuned” by varying the size and composition of the nanocrystal. Nanocrystals preferably absorb a wide spectrum of wavelengths and emit light over a narrow range of wavelengths. The excitation and emission wavelengths are typically different, and non-overlapping. The nanoparticles of a monodisperse population may be characterized in that they produce a fluorescence emission having a relatively narrow wavelength band. Examples of emission widths (FWHM) include less than about 200 nm, less than about 175 nm, less than about 150 nm, less than about 125 nm, less than about 100 nm, less than about 75 nm, less than about 60 nm, less than about 50 nm, less than about 40 nm, less than about 30 nm, less than about 20 nm, and less than about 10 nm. The width of the emission band is preferably less than about 50 nm, and more preferably less than about 20 nm at full width at half maximum (FWHM) of the emission band. The emitted light preferably has a symmetrical distribution of emission wavelength intensities. The emission maximum can generally be at any wavelength from about 200 nm to about 2,000 nm. Examples of emission maxima include about 200 nm, about 400 nm, about 600 nm, about 800 nm, about 1,000 nm, about 1,200 nm, about 1,400 nm, about 1,600 nm, about 1,800 nm, about 2,000 nm, and ranges between any two of these values. In certain embodiments, a green color is desirable, so a wavelength in the green region is selected.

The nanoparticles in some embodiments herein are frequently fluorescent, due to the presence of a fluorescent nanocrystal core. The nanoparticles are often characterized by a fluorescence emission maximum in the visible spectrum, and frequently the fluorescence of a monodisperse population of nanocrystals of some embodiments is characterized in that when irradiated the population emits light for which the peak emission is in the spectral range of from about 470 nm to about 620 nm.

The nanoparticles provided herein are generally bright and stable, providing a quantum yield of greater than about 20%, or greater than about 30%, or greater than about 50%, or greater than about 70%.

The nanoparticles of a monodisperse population for some embodiments may be characterized in that they produce a fluorescence emission having a relatively narrow wavelength band. In some embodiments, the monodisperse particle population is characterized in that when irradiated the population emits light in a bandwidth of less than about 60 nm FWHM, or less than about 50 nm FWHM, or less than about 40 nm FWHM, or less than about 30 nm FWHM, or less than about 25 nm FWHM.

The nanoparticles in some embodiments may comprise a core/shell nanocrystal having a nanocrystal core covered by a semiconductor shell. The thickness of the shell can be adapted to provide desired particle properties. The thickness of the shell affects fluorescence wavelength systematically in a known manner, and has substantial effects on the quantum yield, fluorescence stability, and other photophysical characteristics.

In some embodiments, a semiconductor nanocrystal core is modified to enhance the efficiency and stability of its light emission, prior to ligand modifications described herein, by adding an overcoating layer or shell to the semiconductor nanocrystal core. Having a shell may be preferred, because defects at the surface of the semiconductor nanocrystal can result in traps for electrons or holes that degrade the electronic and optical properties of the semiconductor nanocrystal core, or bring about other non-radiative energy loss mechanisms that either dissipate the energy of an absorbed photon or affect the wavelength of light emission, resulting in broadening of the emission band. An inorganic insulating layer at the surface of the semiconductor nanocrystal core can provide an abrupt jump in the chemical potential at the core-shell interface that greatly diminishes or eliminates energy states that can serve as traps for electrons and holes. This results in higher efficiency in the luminescent process.

Suitable materials for the shell include semiconductor materials having a higher bandgap energy than the semiconductor nanocrystal core. In addition to having a bandgap energy greater than the semiconductor nanocrystal core, suitable materials for the shell should have good conduction and valence band offset with respect to the core semiconductor nanocrystal. Thus, the conduction band is desirably higher in energy and the valence band is desirably lower in energy than those of the core semiconductor nanocrystal. For semiconductor nanocrystal cores that emit energy in the visible (e.g., CdS, CdSe, CdTe, ZnSe, ZnTe, GaP, GaAs) or near IR (e.g., InP, InAs, InSb, PbS, PbSe), a material that has a bandgap energy in the ultraviolet region may be used. Exemplary materials include ZnS, GaN, and magnesium chalcogenides, e.g., MgS, MgSe, and MgTe. For a semiconductor nanocrystal core that emits light in the near IR, materials having a bandgap energy in the visible region, such as CdS or CdSe, may also be used. The preparation of a coated semiconductor nanocrystal may be found in, e.g., Dabbousi et al. (1997) J. Phys. Chem. B 101:9463, Hines et al. (1996) J. Phys. Chem. 100: 468-471, Peng et al. (1997) J. Am. Chem. Soc. 119:7019-7029, and Kuno et al. (1997) J. Phys. Chem. 106:9869. It is also understood in the art that the actual emission wavelength for a particular nanocrystal core depends upon the size of the core as well as its composition, so the categorizations above are approximations, and nanocrystal cores described as emitting in the visible or the near IR can actually emit at longer or shorter wavelengths depending upon the size and shape of the core.

In some embodiments, the metal atoms of a shell layer present on a nanocrystal core are selected from Cd, Zn, Ga and Mg. The second element in these semiconductor shell layers can be selected from S, Se, Te, P, As, N and Sb. In some embodiments, the semiconductor nanocrystal is a core/shell nanocrystal, and the core comprises metal atoms selected from Zn, Cd, In, Ga, and Pb. Some preferred nanocrystal cores include CdS, CdSe, InP, CdTe, ZnSe and ZnTe; and some preferred shell materials include ZnS, ZnSe, CdS, and CdSe.

The nanocrystal can be of any suitable size; typically, it is sized to provide fluorescence emission in the UV-visible portion of the electromagnetic spectrum, since this range is convenient for use in monitoring biological and biochemical events in relevant media. The relationship between size and fluorescence emission wavelength is well known, thus making nanoparticles that emit at a shorter wavelength may require selecting material that gives a suitable wavelength at a small size, such as InP as the core of a core/shell nanocrystal designed to be especially small. Typically the nanocrystals of interest are from about 1 nm to about 100 nm in diameter, or from about 1 to about 50 nm, or from about 1 to about 40 nm, or from about 1 to about 25 nm. For a nanocrystal that is not substantially spherical, e.g. rod-shaped, it may be from about 1 to about 100 nm, or from about 1 to about 50 nm, or from about 1 to about 40 nm, or from about 1 nm to about 20 nm in its largest dimension.

Semiconductor nanocrystals may be made using techniques known in the art. These methods typically produce nanocrystals having a coating of hydrophobic ligands, such as trioctyl phosphine (TOP) or trioctyl phosphine oxide (TOPO), on their surfaces, which helps to protect and stabilize the nanocrystal from rapid degradation. Because the surface of the nanocrystal has many binding sites for such ligands, the typical process results in coating of the exposed surface of the nanocrystal with a layer of alkyl groups at the outer surface, and produces a nanocrystal with a surface that is hydrophobic, i.e., incompatible with water.

In some embodiments, a nanoparticle to be modified comprises a nanocrystal and a surface coating of small-molecule ligands coordinated to the nanocrystal's inorganic surface. In some embodiments, a nanoparticle to be modified comprises a nanocrystal, a surface coating of small-molecule ligands coordinated to the nanocrystal's inorganic surface (i.e. the surface coating is an organic ligand coating), and an additional coating of polymers (such as amphiphilic polymers) over the ligand coating.

### Functionalizing Ligands in the Surface Coating or Other Molecules in Other Coatings of Nanoparticles

In one aspect, provided herein is a method for functionalizing one or more ligands in the surface coating of a nanoparticle by a radical reaction or for functionalizing one or more molecules in another coating of a nanoparticle. A functionalized ligand (or other coating molecule) thus formed has one or more functional groups. Accordingly, as used herein, functionalizing a ligand (or a coating molecule) refers to modifying the ligand (or the coating molecule) by introducing one or more functional groups. In some embodiments, a ligand (or a coating molecule) to be functionalized comprises an aliphatic group (e.g. an alkyl group).

In some embodiments, the ligand to be functionalized is in a surface coating on a semiconductor nanocrystal. The ligand coating on the nanocrystal can be any suitable organic coating known to those skilled in the art, for example, a tri-n-octyl phosphine oxide (TOPO), tri-n-octyl phosphine (TOP), tetradecylphosphonic acid (TDPA), octadecylphosphonic acid (OPA), decylamine, dioctylamine, or an oleic acid coating. In another example, the surface coating of the nanocrystal can comprise a dipeptide ligand coating.

The surface molecules to be functionalized can be any suitable organic compounds that coordinate strongly enough to the nanocrystal to remain on the nanocrystal when it is dispersed in a compatible solvent. Some examples of surface ligands of the nanoparticles to be modified (or functionalized) include derivatives of phosphines, phosphine oxides, phosphonates, carboxylates, amines, imidazoles, thiols, mercaptans, sulfonates, phosphates, and selenates, each of which contains one or more hydrocarbon groups. The hydrocarbon groups are typically alkyl or alkenyl groups having 1-40 or 1-24 carbon atoms per hydrocarbon group per ligand. The phosphines, phosphine oxides and amines can each have 1-3 such hydrocarbon groups per ligand, while the phosphonates and carboxylates have one hydrocarbon group per ligand. In some embodiments, the surface ligands on the initial nanoparticles are selected from TOP, TOPO, TDPA, OPA, decylamine, dioctylamine, oleic acid, and analogs and homologs of any of these having longer or shorter alkyl chains as their hydrocarbon groups, where each alkyl chain is from about 4 to about 20 carbon atoms, or from about 6 to about 20 carbon atoms in length.

In some embodiments, the ligands of the surface coating are complexed directly to a nanocrystal. For example, the ligand complexed to the nanocrystal is a phosphonic acid or phosphine or phosphine oxide or carboxylate or thiol or imidazole binding group that is coordinated to the nanocrystal. In some embodiments, the surface ligands are coordinated to the nanocrystal surface by a binding group, for example the phosphonic acid group of OPA. In some embodiments, the ligand complexed to the nanocrystal comprises a C₁-C₄₀ aliphatic hydrocarbon group, or C₄-C₂₀ aliphatic hydrocarbon group. For example, when the ligand complexed to the nanocrystal has a phosphonic acid or phosphine or phosphine oxide or carboxylate or thiol or imidazole binding group that is coordinated to the nanocrystal, the ligand further comprises at least one C₄-C₂₀ alkyl group, for example, unsubstituted C₄-C₂₀ alkyl chain.

Some examples of amphiphilic polymer (AMP) can be found in U.S. Pat. No. 6,649,138, which is hereby incorporated by reference in its entirety. The polymer coating may also be amphiphilic, having a plurality of hydrophobic domains/regions (for example, alkyl group side chains) or a plurality of hydrophilic domains/regions [for example, side chains comprising hydrophilic groups or polar groups (e.g. carboxylate groups), which can provide/increase water solubility]. In some embodiments, the polymer can be the amphiphilic polymer (AMP). The polymer can have any chain structure, for example, it can be linear or branched, multiple-branched or dendridic, and the polymer may be a homopolymer or copolymer. In the examples of Adams et al., a hydrophobic nanoparticle has an additional layer/coating comprising a molecule that has a hydrophobic domain, plus polar groups. The hydrophobic domain associates with the hydrophobic surface of the nanoparticle through hydrophobic-hydrophobic interactions with organic ligand groups present on the nanocrystal, leaving the polar groups exposed to solvent. The polar groups then make the overall composition water-soluble or -dispersible. The preferred additional layer/coating described in Adams et al. is an amphiphilic polymer (AMP), comprising medium- and/or long-chain alkyl groups to provide the hydrophobic domain, and carboxylate groups to provide water solubility. Thus, some embodiments also provide a method for functionalizing a molecule (such as an amphiphilic polymer) present in a coating over the surface ligands of a nanocrystal. The methods of functionalizing ligands described herein can be used to functionalize other coating molecules (such as amphiphilic polymers) present as an outer coating of a nanoparticle.

### Radical Reactions

In some embodiments, the ligand on the surface of a nanocrystal [or a molecule (such as an amphiphilic polymer) present in a coating over the surface ligand coating of a nanoparticle] to be functionalized comprises an aliphatic hydrocarbon group that has at least one C—H bond. Suitable hydrocarbon aliphatic group can be, for example, a C₁-C₄₀, C₂-C₄₀, C₄-C₄₀, or C₄-C₂₀ aliphatic hydrocarbon group, for example, a C₄-C₂₀ alkyl group or an unsubstituted C₄-C₂₀ alkyl chain. In such embodiments, the method for functionalizing ligands in a surface coating of a nanoparticle (or molecules present in a coating over the ligand surface coating) provided here comprises reacting the aliphatic hydrocarbon group of the ligand or other coating molecule with a reagent capable of forming a radical (a radical forming agent), including a diradical, through a radical reaction. The radical forming reagent is capable of removing a hydrogen atom from the aliphatic group (e.g. alkyl group), whereby the ligand or other coating molecule is functionalized (i.e. the functionalized ligand or molecules comprises a functional group introduced by the radical reaction). The functional group can be attached to the aliphatic hydrocarbon group (e.g. alkyl group) directly or through another moiety.

Some examples of suitable radical forming agents include an enzyme or abzyme capable of removing a hydrogen atom from the aliphatic group (e.g. alkyl group) of the ligand or other coating molecule, for example, cytochrome p450 or similar oxidative enzymes. Other suitable radical forming agents include, e.g., alkyl diazines such as diethyl diazine and azo-bis-isobutyronitrile (AIBN). Some further examples of suitable reagents include a substituted benzophenone (e.g. 4-aminobenzophenone, 4-benzoylbenzoic acid, 4,4′-diaminobenzophenone, 3,3′,4,4′-benzophenone tetracarboxylic acid, 2′,3,4-benzophenone tricarboxylic acid, and 5,5′-carbonyl-bis-trimellitic acid), bis acylphosphine oxides, substituted peroxides, or substituted benzoyl peroxide. Additional examples of suitable radical forming agents include halogenating reagents such as halogen (e.g. bromine or chlorine) or other brominating or chlorinating agents [e.g. NBS, NCS, and a tribromide salt (e.g., phenyl trimethylammonium tribromide)]. In some embodiments, the reagent forms a radical or diradical upon irradiation.

Other suitable radical forming agents include those capable of forming peroxide radicals, for example, substituted benzoyl peroxides, di-tertbutyl peroxide, or peroxides of simple ketones like acetone or methyl ethyl ketone (MEK), which can replace a hydrogen atom of an alkyl group of a ligand with an alkoxy, acyloxy, or hydroxyl group. A substituted benzoyl peroxide, for example, can include a functional group that can be used to crosslink ligands after the substituted benzoyl group is incorporated into a ligand or other coating moiety on a nanocrystal. Similarly, functionalized alkoxy groups or hydroxyl groups introduced by radical reactions can be used with known chemical transformations to crosslink ligands.

In some embodiments, the reagent capable forming a radical (including a diradical) forms a radical upon irradiation or upon heating. In some embodiments, the reagent capable forming a radical (including a diradical) forms a radical upon irradiation.

In some embodiments, the reagent capable of forming a radical is a halogenating reagent such as NBS through a radical reaction. The reaction can produce a radical (such as a halogen radical) that can abstract a hydrogen atom from an alkyl group of a ligand, and add a halogen atom to the alkyl group forming a halo group.

In some embodiments, the reagent capable of forming a radical (including a diradical) used in the radical reaction can be referred to as a radical addition compound. As used herein, a “radical addition compound” is a compound comprising a functional group capable of generating a radical species. A radical addition compound can generate a radical species (including a diradical species) upon irradiation (i.e. is photoactivatible) or upon heating (i.e. is thermally activatible). In some embodiments, the radical addition compound has a photoreactive functionality.

In some embodiments, a radical addition compound reacts with a ligand, or other coating molecule, through a radical addition, thus forming a functionalized ligand. The functionalized ligand or other molecule thus comprises a moiety resulting from the radical reaction of the radical addition compound with the ligand, and the moiety is referred to as a radical addition moiety.

In some embodiments, the reagent capable of forming a radical (including a diradical), for example, a radical addition compound, is a bifunctional compound. A bifunctional compound is one that comprises a first functional group capable of generating a radical species (including a diradical species) and a second functional group capable forming a covalent chemical bond through a non-radical mechanism. The first functional group can generate a radical species (including a diradical species) upon irradiation (i.e. is photoreactive) or upon heating (i.e. is thermoreactive). The first functional group can be, for example, a carbonyl of a substituted benzophenone, a diazine, an azide, or a peroxide linkage (such as in a substituted benzoyl peroxide). The second functional group can be, for example, a reactive halogen, amino, hydroxy, carboxyl group, nitrile, thiol, or a group such as isothiocyanate, alkene, alkyne, vinyl, azide, succinimide, maleimide or the like. Methods for forming covalent bonds with such groups are known in the art.

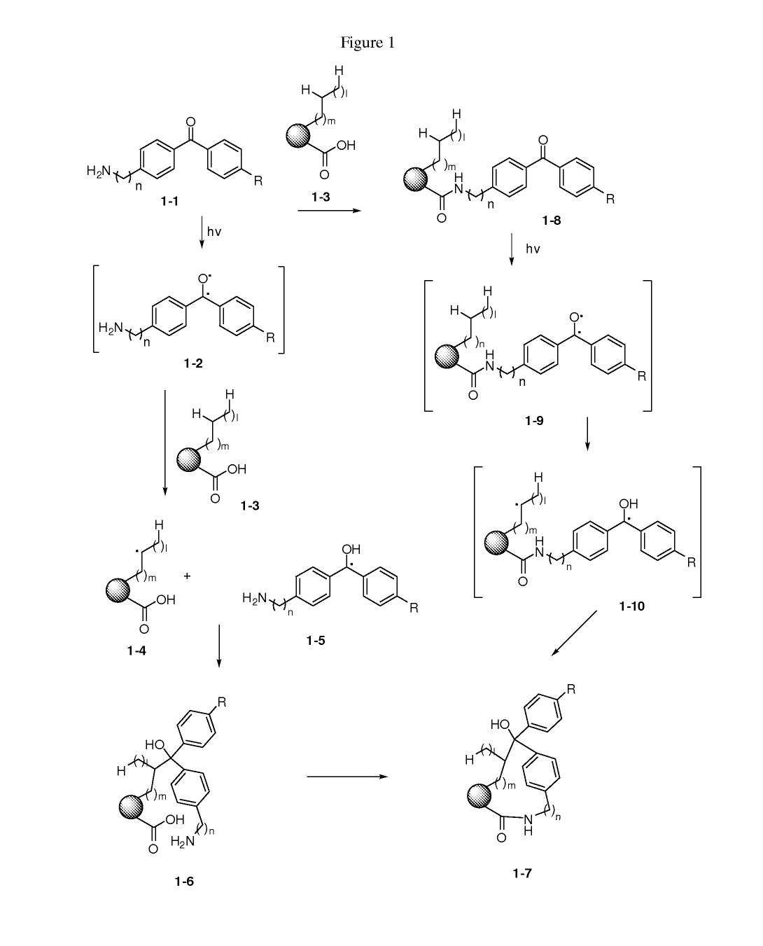

As illustrated in FIG. 1, upon irradiation/photolysis, a substituted benzophenone 1-1 (having an amino group) forms a diradical excited species 1-2 which abstracts a hydrogen atom from an alkyl group of a ligand on the surface of nanoparticle 1-3 to produce an alkyl radical on nanoparticle 1-4 and a ketyl radical 1-5. Then the ketyl radical 1-5 can form a bond with the alkyl radical of the ligand on nanoparticle 1-4, whereby functionalizing the ligand by attaching the substituted benzophenone (having the amino group) to the ligand. The amino group (as a functional group) is added to the ligand through a moiety comprising a phenyl group. The moiety resulting from the substituted benzophenone, which is attached to the ligand as a result of the radical addition, is herein referred to as a reaction addut of the substituted benzophenone.

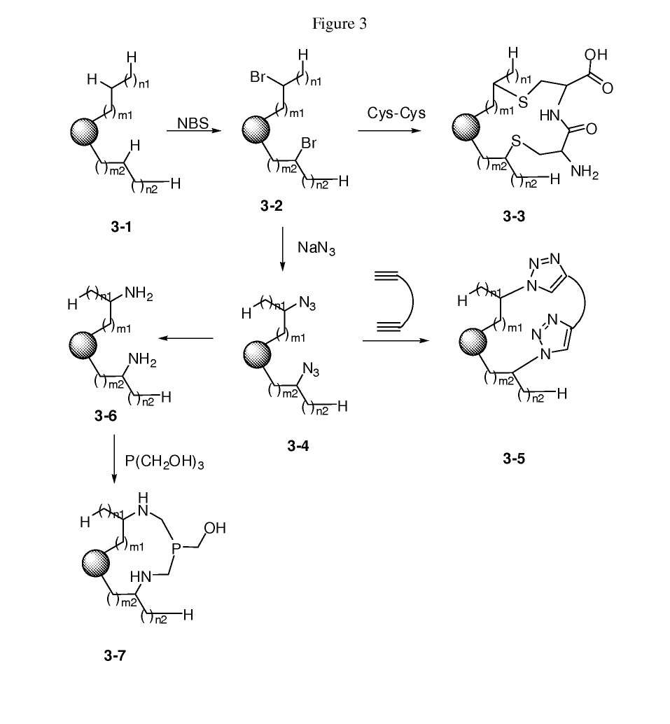

As illustrated in FIG. 3, NBS can be used to brominate an alkyl group of a ligand on the surface of nanoparticle 3-1, whereby functionalizing the ligand [a bromine atom/bromo (as a functional group) is added to the alkyl group of the ligand via a radical reaction].

In some embodiments, the functional group introduced to the functionalized ligand in the surface coating (or a functionalized molecule in the coating over the ligand coating) is attached directly to an aliphatic group (e.g. an alkyl group) of the ligand/molecule to be functionalized. In some embodiments, the functional group introduced to the functionalized ligand/molecule is attached to an aliphatic group (e.g. an alkyl group) of the ligand/molecule to be functionalized through at least one intervening carbon-carbon bond, for example the linkage between the amino group of the functionalized ligand connected to nanoparticle 1-6 of FIG. 1 and the alkyl group.

Certain ligands in the surface coating of a nanoparticle can be a small organic molecule (for example TOPO). In some embodiments, a nanoparticle has an additional coating over the ligand coating, and the additional coating comprises molecules such as polymers (e.g. amphiphilic polymers). For example, the preferred additional layer/coating described in Adams et al. has an amphiphilic polymer (AMP) comprising medium- to long-chain alkyl groups to provide the hydrophobic domain, and carboxylate groups to provide water solubility. A substituted benzophenone, for example 4-amino benzophenone, can be attached to the alkyl groups of the AMP in the preferred additional layer/coating described in Adams et al. upon irradiation (similar to the reactions described in FIG. 1 for forming the functionalized ligand on nanoparticle 1-6).

Use of the radical reactions described herein to introduce the functional groups onto the functionalized ligands/coating molecules may result in low selectivity for the location at which the functional group is attached due to the high reactivity of the radical species. It is also likely that some ligands/coating molecules will be functionalized while others will not. Ligands/coating molecules that are functionalized may add the new functional group at any point on their organic or hydrocarbon portion, producing mixtures of modified ligands/molecules.

In some embodiments, the functionalized ligands/coating molecules that have the added functional groups are regioisomers, meaning they differ in the location of the attachment of the functional group. In some embodiments, the ligands/coating molecules are different from each other by virtue of having different functional groups.

In some embodiments, the functional groups on the functionalized ligands/coating molecules can be halogens, or substituted alkoxy, acyl, or benzophenone moieties. The functional groups can be useful in increasing hydrophilicity of the nanoparticles. The functional groups can undergo chemical modifications to provide other functional groups. The functional groups can also be useful for crosslinking the functionalized ligands/coating molecules to other moieties that are also connected to the same nanoparticles (for example, two functionalized ligands formed by the methods provided here can be crosslinked, or a functionalized ligand formed by the methods provided here can be crosslinked to another pre-existing functionalized ligand).

In some embodiments, the functionalized ligand/coating molecule comprises a reaction adduct of a substituted benzophenone. The substituents on the substituted benzophenone adducts can be any desired substituent, and in some embodiments the substituents are selected for their usefulness in crosslinking ligands/molecules. In other embodiments, at least one of the substituents is selected for its usefulness in enhancing the water dispersability of the nanoparticle. In some embodiments, the substituents are selected for their usefulness as points of attachment for connecting the nanoparticle to other compounds or structures, such as antibodies or enzymes, as is widely practiced in the art. As used here, a reaction adduct of a compound refers to a chemical moiety resulting from a reaction of the compound with another chemical entity. For example, when 4-aminobenzophenone is condensed with a carboxylic acid, then the reaction adduct of the 4-aminobenzophenone is the moiety attached to the ligand/coating molecule through an amide bond. In another example, when 4-aminobenzophenone is reacted with an alkyl compound under radical conditions, the reaction adduct of the 4-aminobenzophenone contains the moiety attached to the alkyl compound through a carbon atom of the alkyl compound.

In some embodiments, at least one functionalized ligand is covalently bonded to another ligand connected to the same nanoparticle. For example, the functionalized ligand can comprise a substituted alkoxy, acyl, or benzophenone moiety, wherein the substituent on the substituted moiety is linked to another ligand connected to the same nanoparticle by a covalent bond before or after it gets bonded to the functionalized ligand. In one such embodiment, the functionalized ligand comprises an reaction adduct of a substituted benzophenone. The substituent of the adduct of the substituted benzophenone is then used to form a covalent bond to another ligand coordinated to the same nanocrystal. In some embodiments, the covalent bond to another ligand is formed by a crosslinking reaction between the substituents on two ligands that are both benzophenone adducts. Suitable crosslinking reactions are known in the art, and are described herein.

In some embodiments, a functionalized ligand formed by the method herein has a newly introduced functional group which can undergo an elimination reaction thus converting the alkyl group to which it was attached to an akenyl group. For example, the alkyl group substituted by hydroxyl can undergo an elimination reaction to result in an alkenyl group. In such embodiments, the functional group that is added to the alkyl group forms an alkenyl group upon occurrence of the elimination reaction.

### Chemical Modification of a Functional Group

A functional group of a functionalized ligand/coating molecule can undergo further chemical modifications (i.e. a functionalized ligand/coating molecule can undergo further chemical modification). For example, an amino group can be reacted with a carboxylic acid group to form an amide/peptide bond (i.e., acylation). See e.g. FIG. 1. In another example, a bromo group can be modified to a hydroxy, alkoxy, or amino group under reaction conditions known to those skilled in the art. In yet another example, a bromo group can be modified to an azide group which can be further modified to an amino group. See e.g. FIG. 1.

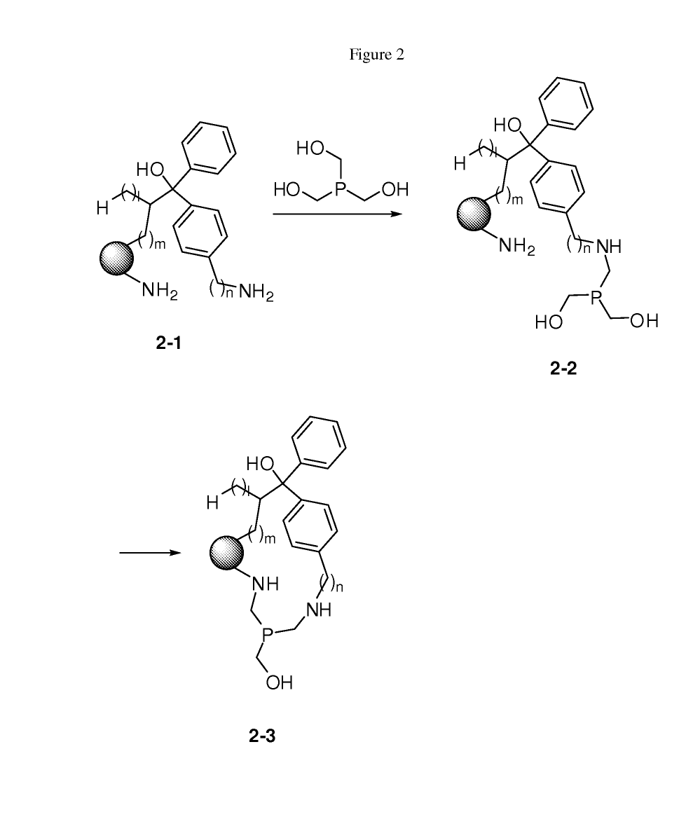

As illustrated in FIG. 2, a benzophenone reaction adduct (having an amino group) on a ligand connected to nanoparticle 2-1 can undergo further chemical modification. It can be reacted with tris(hydroxymethyl)phosphine (THP) or one of other suitable multifunctional crosslinkers well known to the art to form a different functionalized ligand connected to nanoparticle 2-2, which has one or more new functional groups (two more hydroxymethyl groups associated with the phosphine).

The further chemical modification of a functional group on a functionalized ligand/coating molecule can be used to attach the functionalized ligand/coating molecule to another moiety. In some embodiments, the other moiety is connected to the same nanoparticle. In some embodiments, the other moiety can be a part of another ligand connected to the same nanoparticle or another part of the same functionalized ligand. For example, when the functionalized ligand comprises a functionalized alkyl chain of a TOPO, a functional group on one of the functionalized TOPO alkyl chains can be attached to another alkyl chain of the same ligand or another TOPO ligand (which may also functionalized) connected to the same nanoparticle.

In some embodiments, the further chemical modification of a functional group on a functionalized ligand/coating molecule is to provide a different functional group that can be used for crosslinking. In some embodiments, further chemical modification of a functional group on a surface ligand can be used to crosslink the ligand to another surface ligand. As shown in FIG. 3, a bromo can be converted to an azide group, which can be used in a crosslinking reaction through a cycloaddition reaction. For another example, an azide group can be converted to an amino group, which can used in a crosslinking reaction with a crosslinking agent (a crosslinking reagent) such as THP or THPP.

The further chemical modification of a functional group on a functionalized ligand/coating molecule can include linking it to another ligand in the surface coating or another molecule in a coating present over the ligand coating of the same nanoparticle. In some embodiments, the further chemical modifications include linking a functional group (e.g. a newly introduced functional group) of a molecule that is not directly associated with the nanocrystal surface (such as an AMP polymer that is associated via hydrophobic interaction with ligands that are directly complexed to the nanocrystal inorganic surface) to another ligand in the surface coating or another molecule present in a coating over the ligand coating of the same nanoparticle. Suitable methods for such linking or crosslinking to the new functional group are known in the art, and some of these methods are discussed herein.

Modifying an Existing Functionalized Ligand/Molecule on a Nanoparticle with a Bifunctional Molecule Through a Nonradical Reaction

In certain embodiments, an existing functionalized ligand in the surface coating of a nanoparticle, or a molecule (with one or more functional groups) in a coating over the ligand coating, can be chemically modified (or derivatized) by attachment to a bifunctional molecule through a nonradical reaction.

Reacting a ligand or molecule with a bifunctional compound (such as one comprising a photoreactive functionality) can provide a moiety that is the reaction adduct of the bifunctional compound attached to the ligand, which can be either the product of the radical addition of such a bifunctional compound (such as a substituted benzophenone, substituted peroxide, substituted benzoyl peroxide, or similar functionalized radical-forming reacting species) forming a covalent bond to a carbon atom of the ligand/coating molecule, or it can be the product of a reaction of a functional group (such as an amino, hydroxyl, carboxyl, nitrile, or thiol) of the bifunctional compound with a compatible functional group on the ligand/coating molecule on the nanoparticle through a nonradical reaction. In the latter case, the photoreactive functionality is retained in the functionalized ligand/molecule, and further chemical modification including photochemical crosslinking can be performed.

A suitable bifunctional compound comprises reactive functional groups capable of forming a bond to the existing functional group of the functionalized ligand or other coating molecule, through a nonradical mechanism. Those skilled in the art can choose suitable bifunctional compounds in view of the existing functional groups of the surface molecules. For example, if the existing functionalized ligand comprises a carboxyl group, an aminobenzophenone or aminoalkylbenzophenone can be chosen. In some embodiments, a suitable bifunctional compound further comprises one or more functional groups in addition to the one capable of forming a bond with the existing functional group of the functionalized ligand or other coating molecule. The modified functionalized ligand or other molecule comprises a functional group capable of generating a radical species (including a diradical species), as a result of the attachment to the bifunctional compound through a nonradical reaction mechanism. The existing functional group of the existing functionalized ligand or other molecule can be introduced by methods provided herein or by other methods.

As illustrated in FIG. 1, a substituted benzophenone 1-1 (having an amino group) can react with an existing functionalized ligand (having a carboxyl group as the existing functional group) on nanoparticle 1-3 through a nonradical reaction mechanism, and thus to provide a modified functionalized ligand on nanoparticle 1-8. The modified functional ligand has the ketone group of the benzophenone as the functional group capable of generating a radical species.

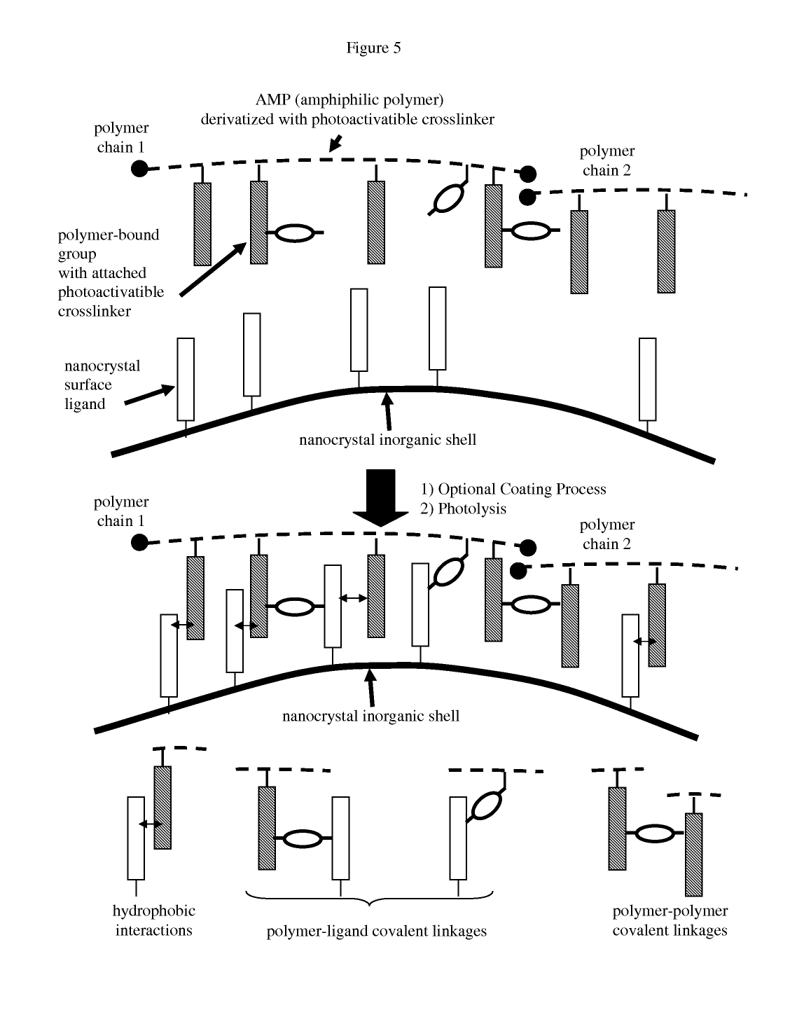

A functionalized coating or molecule on a nanoparticle can be a polymer that has one or more functional groups. Modification of such a polymer, for example an AMP having one or more carboxyl groups, can be carried out by covalently linking the AMP to one or more aminobenzophenones through forming amide bonds between an amino group of an aminobenzophenone and a carboxyl group of the AMP by a nonradical condensation reaction, providing a photoreactive polymer, such as shown in FIG. 5. When such a photoreactive polymer associates with other ligands (having alkyl groups) also connected to the same nanocrystal, photochemical reaction of the benzophenone moiety with the alkyl groups of the other ligands on the nanoparticle can be used to link the AMP to the other ligands (and optionally also to link the AMP molecules to neighboring AMP molecules), as shown in, for example, FIG. 5. Because such a photoreactive polymer can further comprise side chains having alkyl groups (for example, some carboxylic acid groups can form amides with octyl amines), photochemical reaction of the benzophenone adduct can link it to another side chain having an alkyl group on the same AMP or a neighboring AMP molecule, as shown, for example, in FIG. 5.

In some embodiments, a functionalized ligand/coating molecule or a modified functionalized ligand/coating molecule formed by methods provided herein (via either radical or nonradical reaction) can comprise a polar functional group. In some embodiments, a functionalized ligand or a modified functionalized ligand comprises a halogen atom, hydroxyl, an alkoxy group, or a nitrogen atom. Examples of functional groups comprising a nitrogen atom include amino, alkylamino (e.g. methylamino), dialkylamino (e.g. dimethylamino), pyrrolidino, piperidino, 1H-1,2,3-triazol-1-yl, 1H-imidazol-1yl, and the like. In some embodiments, a functionalized ligand or a modified functionalized ligand comprise a halogen atom, hydroxyl, an alkoxy group, or an amino group.

### Linking, Crosslinking and Additional Methods for Making Nanoparticles

In some embodiments, the methods provided herein use a radical addition reaction to functionalize a nanoparticle ligand or a molecule in a coating over the surface ligand coating of a nanoparticle, to enhance its solubility, or to prepare it for connection to other moieties by linking or crosslinking. In some embodiments, the methods provided herein use a radical addition reaction to crosslink a nanoparticle ligand, for example, to another nanoparticle ligand.

In one aspect, provided herein is a method for making a modified nanoparticle comprising a semiconductor nanocrystal and a surface coating over the nanocrystal comprising ligands and attaching a radical addition compound to a ligand of the surface coating, wherein the radical addition compound has one or more reactive substituents.

The modified nanoparticle formed by the method has a functionalized nanoparticle ligand formed by the attachment of the radical addition compound. In some embodiments, the radical addition compound is attached to the ligand through a radical reaction. In some embodiments, the radical addition compound is attached to the ligand through a non-radical reaction.

As used herein, a “radical addition compound” is a compound comprising a functional group capable of generating a radical species. A radical addition compound (or its functional group capable of generating a radical species) generates a radical species (including a diradical species) upon irradiation (i.e. is photoreactive) or upon exposure to heat (i.e. is thermoreactive), and thus becomes suitable for undergoing a radical reaction. In some embodiments, the radical addition compound has a photoreactive functionality.

A bifunctional compound is a radical addition compound, and it can be a compound that has a photoreactive functionality that can be used to form a bond to a carbon atom of a ligand (or a molecule) through radical reaction, plus one or more additional functional groups capable of being used in a non-radical reaction to form a bond to a ligand (or a molecule) on a nanocrystal. Examples of one or more additional functional groups amenable to the nonradical reaction include amines, carboxylates, hydroxyls, thiols, and the like. Methods for connecting these types of groups to one another in a mix-and-match way are well known in the art.

Where a bifunctional compound is used as the radical addition compound, the method may further include attaching the bifunctional compound, after it is linked to the ligand/molecule, to another moiety.

In some embodiments, the other moiety is a second ligand of the surface coating. In some embodiments, the other moiety is another molecule in a coating covering the surface ligand layer of the nanoparticle.

In some embodiments where a bifunctional compound is used as the radical addition compound, one of the reactions can be a radical reaction and the other non-radical reaction. The two bond-forming reactions can be performed in either order. In some embodiments, the reaction to attach the bifunctional compound to a ligand is a radical reaction, and the reaction to attach the bifunctional compound to a second ligand is a non-radical reaction. The step of attaching the bifunctional compound to a second ligand using a nonradical reaction can involve reaction between a functional group of the bifunctional compound and a functional group on the second ligand. Methods for making such connections are well known in the art. The functional group on the second ligand can, in some embodiments, be provided by another bifunctional molecule that has been added to the second ligand as described above.

Reacting a ligand on the nanoparticle with a bifunctional compound comprising a photoreactive functionality can provide a “radical addition moiety”, which can be either the product of the radical addition of such a bifunctional compound (such as a substituted benzophenone, substituted peroxide, substituted benzoyl peroxide, or similar functionalized radical-forming reacting species) forming a covalent bond to a carbon atom of the ligand, or it can be the product of a reaction of a functional group (such as an amine, hydroxyl, carboxyl, nitrile, or thiol) of the bifunctional compound with a compatible functional group on the ligand on the nanoparticle. In the latter case, the photoreactive functionality is retained in the functionalized ligand, and further chemical modification including photochemical crosslinking can be performed.

In another aspect, some embodiments provide a method for crosslinking ligands of a nanoparticle comprising providing a nanoparticle including a semiconductor nanocrystal and a surface coating comprising ligands, functionalizing a surface coating ligand through a radical addition reaction to form a functionalized surface coating ligand with a radical addition moiety, and crosslinking the functionalized surface coating ligand to a different surface coating ligand of the nanoparticle coating. In some embodiments, the crosslinking comprises introducing a crosslinking agent that is reactive with the radical addition moiety on the functionalized surface coating ligand.

In some embodiments, the crosslinking methods provided here provide stabilized nanoparticles. “Stabilized” as used herein means the treated nanoparticles exhibit improved performance in at least one measurement of stability, which can include having a higher quantum yield in a particular buffer or solvent; maintaining quantum yield better during photolysis (greater resistance to photobleaching); better colloidal stability, or less tendency to precipitate or flocculate from solution or to form aggregates or microaggregates in solution; and improved resistance to dilution dimming, which is a loss of brightness (reduction in quantum yield) that can occur at low concentrations, e.g., below about 100 nM nanoparticle concentration, and which is distinct from photobleaching, or lowered tendency for ligands to dissociate from nanocrystal inorganic surfaces. The ligand crosslinking reactions described herein promote stability of nanoparticles treated by these methods.

Some embodiments provide a nanoparticle comprising (1) a semiconductor nanocrystal and (2) a coating comprising a first ligand that comprises at least one alkyl carbon atom and a radical addition moiety attached to the alkyl carbon atom of the ligand. In some embodiments, the radical addition moiety can undergo further chemical modification, for example, being converted to another moiety comprising a functional group to increase hydrophilicity. In some embodiments, the radical addition moiety has one or more reactive or photoreactive groups that can be used to covalently link the radical addition moiety to a second ligand on the nanocrystal. The radical addition moiety is a moiety introduced to the ligand by a radical addition reaction.

As used herein, a “radical addition moiety” is a reaction product of a radical addition compound (such as a substituted benzophenone, substituted peroxide, substituted benzoyl peroxide, or similar functionalized radical-forming reacting species) to a carbon atom of a ligand (or a molecule in a coating). It can be the reaction product of a radical compound by a radical addition reaction. Where a radical addition compound is a bifunctional compound, a radical addition moiety formed by it can be either the product of the radical addition of such a bifunctional compound, or it can be the product of a reaction of a functional group (such as an amine, hydroxyl, carboxyl, nitrile, or thiol) of the bifunctional compound with a compatible functional group on the ligand on the nanoparticle. In the latter case, the photoreactive functionality is retained in the functionalized ligand, and further chemical modification, including photochemical crosslinking, can be performed.

Examples of suitable radical addition reactions include, but are not limited to, radical halogenation reactions using halogen (e.g. bromine or chlorine) or halogenating agents (e.g. brominating or chlorinating agents like NBS or NCS), and tribromide salts (e.g., phenyl trimethylammonium tribromide), for example. These reactions can produce a halogen radical that can abstract a hydrogen atom from an alkyl group of a ligand, and replace the hydrogen atom with another halogen atom (halide or halo group). The halo group on the ligand can undergo further chemical modifications, for example, being converted to an amino, hydroxyl, or alkoxy group to improve hydrophilicity or chemoselectivity. In some embodiments, a halide group can then be used in a variety of additional reactions to promote water solubility, or to crosslink ligands to increase stability, or to attach the nanoparticle to another moiety. Examples of such additional reactions include, but are not limited to, nucleophilic substitution reactions with strong nucleophiles like thiols or azide anions. A dithiol like butane-1,4-dithiol (crosslinking agent), for example, can be used to crosslink two ligand molecules each of which has been modified to contain a halide group. Azide anions can also be used to displace halides, providing ligands comprising an azide group; which in turn can be used to crosslink ligands by contacting the nanoparticles with, e.g., 1,5-hexadiyne (crosslinking agent). The terminal acetylenes of the hexadiyne can undergo cycloaddition reactions with two azide groups to provide crosslinking. These and other exemplary functionalization and crosslinking steps are depicted in FIG. 3. Numerous homo- and heterobifunctional crosslinking agents useful for this purpose known in the art are available commercially, for example, from Thermo Scientific Pierce Protein Research Products (Rockford, Ill. or Molecular Biosciences, Inc. (Boulder, Colo.).

Other suitable radical addition reactions can employ peroxide radicals formed by, for example, substituted benzoyl peroxides, di-tertbutyl peroxide, or peroxides of simple ketones like acetone or methyl ethyl ketone (MEK), which can replace a hydrogen atom of an alkyl group of a ligand with an alkoxy, acyloxy, or hydroxyl group. A substituted benzoyl peroxide, for example, can include a functional group that can be used to crosslink ligands after the substituted benzoyl group is incorporated into a ligand on a nanocrystal. Similarly, functionalized alkoxy groups or hydroxyl groups introduced by radical reactions can be used with known chemical transformations to crosslink ligands. Other suitable radical-generating species for use in the embodiments include, e.g., alkyl diazines such as diethyl diazine and azo-bis-isobutyronitrile (AIBN). Other suitable radical reactions for introducing a functional group onto an alkyl group utilize, for example, cytochrome p450 or similar oxidative enzymes, or Gif reaction conditions that resemble enzymatic hydroxylation reactions, or catalytic or enzymatic dehydrogenations to introduce carbon-carbon double bonds into ligands on a nanocrystal.

In some embodiments, the step of introducing a functional group to a ligand is followed by a step that crosslinks the newly introduced functional group to another ligand having another newly introduced functional group, which may be the same as the first one or different from it. Alternatively, the new functional group can be linked to another functional group already present on ligands residing on the nanoparticle surface. Alternatively, the new functional group can be linked to another molecule that is not directly associated with the nanocrystal surface, such as an AMP polymer that is hydrophobically associated with the ligands that are directly complexed to the nanocrystal surface. Suitable methods for such linking or crosslinking to the new functional group are known in the art, and some of these methods are discussed herein.

The quantity of crosslinking compound to be used can be estimated based on the number of nanoparticles to be crosslinked and the relative thickness of the coating to be crosslinked.

In some embodiments, a substituted benzophenone may be used for functionalizing and/or crosslinking nanocrystal ligands. A substituted benzophenone for use in the compositions and methods of this disclosure may have one or more substituents that can participate in crosslinking. Suitable substituents for the benzophenones include, but are not limited to, amines, hydroxyl, halo, CN, thiol, carboxyl, heterocyclyl, heteroaryl, alkenyl, alkynyl, formyl, ester, ketone or other acyl groups. Examples of a substituted benzophenone include 4-aminobenzophenone, 4-benzoylbenzoic acid, 4,4′-diaminobenzophenone, 3,3′,4,4′-benzophenone tetracarboxylic acid, 2′,3,4-benzophenone tricarboxylic acid, and 5,5′-carbonyl-bis-trimellitic acid. Other substituted benzophenones useful in the methods of the disclosure include aminomethyl-, diaminomethyl-, and diamino-benzophenones. Any suitable photoreactive amine can be used in place of the substituted benzophenones, as well as any photoreactive di, tri or polyamine compounds.

A substituted benzophenone for crosslinking can be attached to a ligand of the nanoparticle by photochemical addition, using photolysis to generate a ketyl radical species from the benzophenone in solution. This is depicted in FIG. 1, which shows the diradical excited species 1-2 that is formed upon irradiation to benzophenone 1-1, and illustrates how it abstracts a hydrogen atom from an alkyl group to produce a ketyl radical 1-5 and an alkyl radical 1-4. The ketyl radical then can form a bond to the alkyl radical of a molecule it encounters.

The ligands of a ligand-coated nanocrystal are typically solvent-exposed. Thus, photolysis of a substituted benzophenone in the presence of a ligand-coated nanocrystal may cause some of the ketyl radical of the benzophenone to react with and become attached to a ligand on the nanocrystal which contains a C—H bond. For example, FIG. 1 shows modalities of the radical addition of a substituted benzophenone to a nanoparticle ligand connected to nanoparticle 1-3 which may produce a ligand comprising a benzophenone adduct on nanoparticle 1-6 where the carbonyl carbon of the benzophenone is covalently linked to a carbon of the nanoparticle ligand. This photochemical linking of the benzophenone carbonyl to a ligand without using a functional group of the ligand may be referred to as grafting, which permits introduction of one or more functional groups onto an alkyl group of a ligand without a need for the ligand to have any reactive functionality initially. Radical addition reactions may be used to functionalize and/or crosslink a variety of hydrocarbon-containing ligands.

After a grafting step is done, crosslinking may require an additional step to link an amine or other reactive substituent of the benzophenone adduct with a functional group (FG) such as an amino group or an carboxyl group on a nearby ligand. This crosslinking step can be done in a variety of ways such as, for example, with THP for linking two or more amino groups (such as in FIG. 2); or with a peptide/amide bond-forming reagent and using condensation reactions linking an amino group to a carboxyl group such as the step of forming nanoparticle 1-6 from nanoparticle 1-4 in FIG. 1).

Examples of a radical addition reagent that may be used to form an adduct with a nanoparticle ligand (i.e. forming a radical addition moiety) include substituted alkyls, substituted benzoyls, and substituted benzophenones that can form radicals capable of abstracting hydrogen atoms from a nonfunctionalized alkyl group to initiate functionalization of the nonfunctionalized alkyl group. In some embodiments, a radical addition reagent may further comprise one or more reactive substituents in addition to the functional group capable of generating a radical species. In some embodiments, reactive substituents on these reagents, after the radical reaction with a ligand, can undergo further chemical modification (including crosslinking the ligand to another ligand). Examples of reactive substituents for these reagents that will be available for crosslinking to other ligands or other molecules to be connected to the nanoparticle once the adduct is formed include, but are not limited to, amines, halogens, hydroxyls, nitriles, mercaptans, carboxyls, heterocyclics, heteroaryls, and alkyls substituted with at least one amine, halogen, hydroxyl, nitrile, mercapto, carboxyl, heterocyclic, or heteroaryl group. In some embodiments, at least one of the substituents of the group added by the radical reaction may be polar enough to promote water solubility. However, this is not required, because the reactive substituent or functionality may be modified to incorporate other groups to provide water solubility, and because the nanocrystals are useful in applications that do not require water solubility. In some embodiments, reactive substituents on a substituted benzophenone for use in the methods provided herein include amine, carboxylate, and halogen, such as Cl and Br.

The substituent(s) on the alkyl or benzoyl groups can be at any position, and substituents on the benzophenone can be at any position(s) on either or both phenyl rings. Optionally, a benzoyl or one phenyl ring of a benzophenone may have two substituents, or each phenyl ring can have one substituent, or each phenyl ring can have more than one substituent. In some embodiments, a substituent is at position 3 or position 4 (meta or para positions) of one or both phenyl rings, since these positions put the substituent further from the reactive center that forms a bond to the ligand.

In some embodiments, at least one substituent is present at the 4-position of one of the two phenyl rings. Some preferred embodiments of the substituents on the substituted benzophenones include 3-amino, 4-amino, 3,3′-diamino, and 4,4′-diamino groups. These amino groups can be unsubstituted, or they can be substituted with an alkyl group, or more typically with an acyl group. In some embodiments, one of the amino groups is linked via a carbonyl group (an amide linker) to a ligand on a nanoparticle prior to photoactivation to form the ketyl, which then forms a covalent bond as illustrated in FIG. 1 to a different ligand on the nanocrystal, resulting in crosslinking of the ligands.

The methods can further include an additional step of using a substituent on the substituted benzophenone group, alkyl group, or benzoyl group, to react with a functional group on a ligand on the surface of the nanocrystal, or with other moieties. In some embodiments, this additional step is used to link one benzophenone moiety, alkyl or benzoyl that is attached to a first ligand on the nanocrystal to another substituted group attached to a second ligand on the nanocrystal—the substituent on the second substituted group serves as a functional group, and is on the second ligand, thus linking them together provides crosslinking of the first and second ligands. In such embodiments, crosslinking is achieved by linking two functionalized ligands through their respective substituent on the substituted benzophenone group, alkyl group, or benzoyl group. Thus in such embodiments, crosslinking is achieved without using any functional groups provided by the initial nanocrystal ligands, because when a plurality of substituted groups (alkyls, benzoyls, benzophenones) are attached (grafted) onto ligands on a nanocrystal, these substituted groups provide functional groups that can be linked to each other using a linking reagent and linking step.

The additional step can be performed either before or after the photolysis step described above that is used to graft a substituted benzophenone onto nanocrystal ligands. In some embodiments, the photolysis step to graft a benzophenone onto the ligand, forming a benzophenone-ligand adduct, is done first, before any other connection is made between the nanoparticle and the benzophenone. In other embodiments, the benzophenone is linked to a ligand first, utilizing a substituent on the benzophenone and a functional group on the ligand through a nonradical reaction mechanism; and then the benzophenone photochemical radical reaction step is performed, to form a benzophenone-ligand adduct that is already linked by a substituent on the benzophenone to another ligand on the nanoparticle. This additional step can utilize a variety of different substituents, provided that the substituents are compatible with a crosslinking reaction that can link the benzophenone group with another ligand on the nanocrystal. An amine is a preferred substituent for this purpose, and 4-aminobenzophenone is a preferred substituted benzophenone for use in these methods. In some embodiments wherein the additional step is performed before the photolysis step described above, the photolysis step forms a benzophenone-ligand adduct that is already linked by a substituent on the benzophenone to another ligand on the nanoparticle, thus crosslinking two ligands. In such embodiments, the crosslinking step is optional.

The additional step can require the use of an additional crosslinking reagent (or linking/coupling reagent). The additional crosslinking reagent is chosen to be compatible with the substituent on the benzophenone or other group being used on the ligand, and to be capable of linking that group or substituent to a functional group on another ligand on the nanocrystal. For example, if a first ligand on the nanocrystal is an amine group, a benzophenone-ligand adduct formed by connecting the substituted benzophenone with a second ligand on the same nanoparticle can be further linked to the amine group of the first ligand by using a suitable reagent. FIG. 1 provides an example wherein a benzophenone-ligand adduct is formed by photochemical grafting of the substituted benzophenone onto one ligand on a nanoparticle, then crosslinking by forming a covalent link between the substituent on the substituted benzophenone adduct and a second ligand.

Examples of substituents that can be used for crosslinking include carboxyl groups; amines; halides; hydroxy; acyl groups (formyl or ester); N-hydroxysuccinimidyloxycarbonyl (an NHS ester of a carboxyl group), azide groups, N-maleimide groups, and isothiocyanate groups. FIG. 3 depicts some crosslinking examples.

Examples of substituents that can be used for crosslinking can be found in R. P. Haugland, HANDBOOK OF FLUORESCENT PROBES AND RESEARCH CHEMICALS, (Molecular Probes, Eugene 2001), and Thomas M. Bauer, A GUIDE TO FLUORESCENT PROBES AND LABELING TECHNOLOGIES (Invitrogen, Carlsbad 2005).

Examples of substituents and linkers that can be used for crosslinking are given in Greg T. Hermanson, BIOCONJUGATE TECHNIQUES (1996).

As an example of the additional crosslinking step, if a substituent on the substituted benzophenone is an amine, the adduct of the substituted benzophenone with another ligand on the nanocrystal can be crosslinked to an amine on the other ligand. The other amine can be provided as a functional group on other ligands, or it can be an amine provided by another amine-substituted benzophenone-ligand adduct involving another ligand on the nanocrystal. The crosslinking step can then utilize any suitable method or reagent for crosslinking two amine groups, for example, THP can be used a crosslinking reagent.

Methods for crosslinking are known in the art; for example, two amine groups can be linked with a dicarboxylic acid (e.g. glutaric acid) using amide bond-forming reagents such as a carbodiimide (CDI). Where THP or THPP is used for crosslinking, the crosslinking reaction can also include a suitable diamine (e.g., ethylene diamine, or a group of formula H₂N—(CH₂)ₓ—NH₂ wherein x is 2-6) that further promotes crosslinking between the phosphine linkers that become incorporated in the crosslinking step.

In another example, two amine groups on different ligands of a nanocrystal can be linked using tris(hydroxymethyl)phosphine (THP) or tris(hydroxymethyl)phosphonium propionate (THPP). An exemplary crosslinking reaction using THP is depicted in FIG. 2, which starts with a benzophenone adduct 2-1 (which can be formed by a similar method to that described for forming 1-6 by 1-4 and 1-5 of FIG. 1), using an amino functional group (FG) on an adjacent ligand. These reagents not only crosslink two amines, they also introduce a new polar group, a phosphine (or phosphine plus a hydroxymethyl group), which may enhance hydrophilicity and water solubility of the nanoparticle. Thus certain methods described here can be used to add an amine or other functional group to ligands on a nanocrystal, and a subsequent step to crosslink the ligands can be included.

Other suitable radical-generating species for use in some embodiments include, e.g., substituted alkyl diazines such as diethyl diazine and azo-bis-isobutyronitrile (AIBN).

Each of the substituted groups (substituted organic peroxides, such as substituted benzoyl peroxides, etc.) can be substituted with the same substituents that can be present as the substituent on a substituted benzophenone, and the adducts of these peroxide reactants with ligands on a nanocrystal can be used to crosslink the ligands by the same types of reaction used to crosslink the substituted benzophenone adducts described herein.

In one aspect, the disclosure provides a nanoparticle comprising a semiconductor nanocrystal and a coating comprising a plurality of ligands that are coordinated to the nanocrystal inorganic shell surface by a coordinating group (for example a phosphonic acid group), wherein each ligand comprises a (new or added) functional group that is not directly coordinated to the nanocrystal inorganic surface, and wherein the ligands are not identical to each other. Use of the radical reactions described herein to introduce the functional groups onto the ligands may result in low selectivity (thus undergoing random or quasi-random insertion) for the location at which the functional group is attached due to the high reactivity of the radical species. It is also likely that some ligands will be functionalized while others will not. Ligands that are functionalized may add the new functional group at any physically accessible point on their organic or hydrocarbon portion, producing mixtures of modified ligands/molecules.

In some embodiments, the ligands that have added functional groups are thus regioisomers, meaning they differ in the location of the attachment of the functional group. In other embodiments, the ligands are different from each other by virtue of having different functional groups.

In some embodiments, the functional groups on the ligands are halogens, or substituted alkoxy, acyl, or benzophenone moieties. The functional groups can be useful in increasing hydrophilicity of the nanoparticles. The functional groups can undergo chemical modifications to provide other functional groups. The functional groups are often groups useful for crosslinking ligands on the nanocrystal or nanoparticles.

In some embodiments, the functional groups are substituted benzophenone moieties, so the ligands having functional groups are substituted benzophenone adducts. The substituents on the substituted benzophenone moieties can be any desired substituent, and in some embodiments the substituents are selected for their usefulness in crosslinking ligands. In other embodiments, at least one of the substituents is selected for its usefulness in enhancing the water dispersability of the nanoparticle. In some embodiments, the substituents are selected for their usefulness as points of attachment for connecting the nanoparticle to other compounds or structures, such as antibodies or enzymes, as is widely practiced in the art.

In some embodiments, at least one functionalized ligand is covalently bonded to another ligand on the same nanoparticle. For example, the functionalized ligand can comprise a substituted alkoxy, acyl, or benzophenone moiety, wherein the substituent on the substituted group is linked to another ligand on the nanoparticle by a covalent bond before or after it gets bonded to the functionalized ligand. In one such embodiment, the functional group is a substituted benzophenone moiety. It is attached covalently to a first ligand on the nanocrystal, and its substituent is then used to form a covalent bond to another ligand coordinated to the same nanocrystal. In some embodiments, the covalent bond to another ligand is formed by a crosslinking reaction between the substituents on two ligands that are both benzophenone adducts. Suitable crosslinking reactions are known in the art, and are described herein.

### Methods of Modifying or Stabilizing Nanoparticles, Novel Nanoparticles, and Compositions Thereof

In another aspect provided herein, a method for making a modified or stabilized nanoparticle may include providing a nanoparticle including a semiconductor nanocrystal and a surface coating comprising ligands that are coordinated to the nanocrystal, using a radical reaction to attach an additional group to a first ligand of the nanocrystal coating to form a functionalized ligand, and using a functional group on the functionalized ligand to form a bond to a second ligand or to a functional group on a second ligand.

“Stabilized” as used herein means the treated nanoparticles exhibit improved performance in at least one measurement of stability, which can include having a higher quantum yield in a particular buffer or solvent; maintaining quantum yield better during photolysis (greater resistance to photobleaching); better colloidal stability, or less tendency to precipitate or flocculate from solution or to to form aggregates or microaggregates in solution; and improved resistance to dilution dimming, which is a loss of brightness (reduction in quantum yield) that can occur at low concentrations, e.g., below about 100 nM nanoparticle concentration, and which is distinct from photobleaching, or lowered tendency for ligands to dissociate from nanocrystal inorganic surfaces. The ligand crosslinking reactions described herein promote stability of nanoparticles treated by these methods.

The ligands can be any suitable ligands described herein. In some embodiments, the ligand comprises 1-40 or 2-40 carbon atoms and at least one nanocrystal-binding group such as a phosphonate, phosphinate, carboxyl, amine, thiol, imidazole, phosphine, or phosphine oxide. The functionalized ligand comprises at least one functional group that can be introduced onto the ligand by a radical reaction, such as an acyl group, alkoxy group, or benzophenone moiety, each of which can be substituted. The functionalized ligand comprises 2-100 atoms selected from H, C, N, O, S, P, Si, and halo, and comprises one or more functional groups in addition to a nanocrystal-binding group. In some embodiments, the ligand may include a dipeptide or a tripeptide comprising naturally occurring alpha-amino acids such as the 20 essential amino acids.

The crosslinking steps form a covalent bond between the first ligand and the second ligand that are both bound directly on a single nanocrystal. The first and second ligands can comprise at least one branched or unbranched alkyl chain having up to 40 carbon atoms, typically 6-24 carbon atoms.

In some of these embodiments, the additional group on the functionalized ligand is a substituted benzophenone moiety, and the substituents on the benzophenone are selected from amino, hydroxyl, halo, nitrile, mercapto, carboxyl, heterocyclic, heteroaryl, and C1-C10 alkyl, where the heterocyclic, heteroaryl and alkyl can be substituted with one or more amino, hydroxyl, halo, nitrile, mercapto, or carboxyl groups. In some embodiments, at least one substituent on the substituted benzophenone moiety is a water-solubilizing or polar substituent.

In some embodiments, the substituted benzophenone moiety is derived from an aminobenzophenone, or a halobenzene; specific examples suitable for these methods include benzophenone moieties derived from 4-aminobenzophenone or 4-halobenzophenone. In some embodiments, the step of attaching a substituted benzophenone to a first ligand of the nanocrystal coating comprises irradiating a substituted benzophenone in the presence of a first ligand on a nanocrystal, whereby the substituted benzophenone reacts with the first ligand to form a substituted benzophenone adduct.

The step of forming a bond between the substituent on the substituted benzophenone moiety and the functional group on the second ligand can be performed before or after putting the additional group on the first ligand. It can be accomplished with any suitable reaction that is compatible with the nanoparticle and with the functionality provided for crosslinking. In some embodiments, this step uses an amide bond-forming reagent, many of which are well known in the art, e.g., carbodiimides, carbonyl diimidazole, and the like. In some embodiments, a hydroxymethyl phosphine compound (THP, THPP) is used for the step of forming a bond between the substituent on the substituted benzophenone moiety and the second ligand.

In another aspect, provided herein, a method for making a modified or stabilized nanoparticle may include providing a nanoparticle including a semiconductor nanocrystal and a surface coating comprising ligands that are coordinated to the nanocrystal, using a nonradical reaction to attach a bifunctional molecule to a first ligand of the nanocrystal surface coating to form a modified ligand, and using a functional group on the modified ligand to form a bond to a second ligand or to a functional group on a second ligand.

Thus, the non-radical reaction provides polymers that are derivitized with a radical generation species, such as an amphiphilic polymer substituted benzophenone, leading to production of radical addition products capable of reacting with a small molecule ligand that is directly bound to the surface of the nanocrystal.

In another aspect provided herein, a method for making a modified/stabilized nanoparticle may include providing a nanoparticle including a semiconductor nanocrystal, a surface coating over the nanocrystal comprising ligands, and a polymer coating (such as an AMP coating) overlaying the surface ligand coating comprising amphiphilic polymers, and attaching a bifunctional compound to a first polymer molecule in the polymer coating (such as a first amphiphilic polymer in the AMP coating) whereby forming a first modified polymer molecule in the polymer coating (such as a first modified amphiphilic polymer in the AMP coating).

In some embodiments, the AMP coating contains an alkylamine-substituted polyacrylic acid, such as those referred to as AMP groups, which can stably be bound to the nanocrystal through hydrophobic interactions with ligands on the inorganic surface of the nanocrystal.

In some embodiments, the bifunctional compound is photoreactive. In some embodiments, the bifunctional compound is a substituted benzophenon, for example, 4-aminobenzophenone, 4-benzoylbenzoic acid, 4,4′-diaminobenzophenone, 3,3′,4,4′-benzophenone tetracarboxylic acid, 2′,3,4-benzophenone tricarboxylic acid, or 5,5′-carbonyl-bis-trimellitic acid. In some embodiments, the bifunctional compound is an aminobenzophenone such as 4-aminobenzophenone or 4,4′-diaminobenzophenone.

In some embodiments, attaching the bifunctional compound to the first amphiphilic polymer is through a radical mechanism, and wherein the first amphiphilic polymer comprises at least one C—H bond. For example, 4-aminobenzophenone can be attached to the backbone or an alkyl side chain of the first amphiphilic polymer upon irradiation.

In some embodiments, attaching the bifunctional compound to the first amphiphilic polymer is through a nonradical mechanism wherein the first amphiphilic polymer comprises a functional group capable of forming a covalent bond to the bifunctional compound through the non-radical mechanism. For example, wherein the first amphiphilic polymer has a carboxylic group, the carboxylic group can be linked to a 4-aminobenzophenone or 4,4′-diaminobenzophenone molecule through a nonradical reaction (for example, in the presence of an amide bond forming coupling reagent).

After the bifunctional compound is attached to the first amphiphilic polymer, the first modified amphiphilic polymer may have one or more reactive or photoreactive functional groups, which are suitable for linking to other moieties (including crosslinking). For example, where a 4-aminobenzophenone molecule is attached to the first amphiphilic polymer upon irradiation, the amino group (of the 4-aminobenzophenone-adduct) can be used for linking to other moieties (including crosslinking). For another example, where a 4-aminobenzophenone molecule is attached to the first amphiphilic polymer having a carboxylic group through a nonradical reaction, the photoreactive functionality (i.e., the carbonyl group of the 4-aminobenzophenone-adduct) is retained can be used for linking to other moieties (including crosslinking) through a radical mechanism.

In some embodiments, the first modified amphiphilic polymer is further crosslinked to another moiety that is also connected (directly or indirectly) to the nanoparticle. In some examples, the first modified amphiphilic polymer is crosslinked to one or more neighboring AMP molecules. In some examples, the first modified amphiphilic polymer is crosslinked to one or more ligands in the surface coating. In some examples, the first modified amphiphilic polymer is crosslinked to one or more neighboring AMP molecules In some embodiments, the first modified amphiphilic polymer is crosslinked to another moiety that is also connected (directly or indirectly) to the nanoparticle through a nonradical mechanism. In such embodiments, the first modified amphiphilic polymer comprises a functional group capable of forming a covalent bond to the other moiety through a non-radical mechanism. In other embodiments, the first modified amphiphilic polymer is crosslinked to another moiety that is also connected (directly or indirectly) to the nanoparticle through a radical mechanism. In such embodiments, the other moiety comprises at least one C—H bond. In some embodiments, the first modified amphiphilic polymer is crosslinked to another moiety that is also connected (directly or indirectly) to the nanoparticle by using (in the presence of) a suitable crosslinking reagent such as THP or THPP.

In another aspect, provided herein is a nanoparticle made by the methods described above for functionalizing and/or crosslinking ligands on a nanocrystal.

In another aspect, provided herein is a nanoparticle comprising a semiconductor nanocrystal; and a surface coating over the semiconductor nanocrystal comprising ligands, wherein a ligand in the surface coating comprises a radical addition moiety and wherein the radical addition moiety has one or more functional groups. In some embodiments, the ligand comprising the radical addition moiety is crosslinked, for example, to another ligand that is in the surface coating.

In some embodiments, the ligand comprising the radical addition moiety comprises an alkyl group; the radical addition moiety is attached to a carbon atom of the alkyl, and the radical addition moiety has one or more reactive or photoreactive groups. In some other embodiments, the radical addition moiety is attached to the ligand through a functional group that is not photoreactive, and the radical addition moiety has one or more photoreactive groups. In some embodiments, the radical addition moiety comprises a reaction adduct of a bifunctional compound selected from the group of a substituted benzophenone, a substituted alkoxy, a substituted acyl, a diazo ester, an aryl azide, and a diazirine. In some further embodiments, the radical addition moiety comprises a reaction adduct of a bifunctional compound that is a substituted benzophenone. In some embodiments, the substituted benzophenone has one or more reactive substituents selected from amino, hydroxyl, halo, nitrile, mercapto, carboxyl, heterocyclic, heteroaryl, and an alkyl group, wherein the alkyl group is substituted with one or more reactive substituents selected from amino, hydroxyl, halo, nitrile, mercapto, carboxyl, heterocyclic, and heteroaryl. In some embodiments, the substituted benzophenone is selected from 4-aminobenzophenone, 4-benzoylbenzoic acid, 4,4′-diaminobenzophenone, 3,3′,4,4′-benzophenone tetracarboxylic acid, 2′,3,4-benzophenone tricarboxylic acid, and 5,5′-carbonyl-bis-trimellitic acid. Where the radical addition moiety is a reaction adduct of a bifunctional molecule, the adduct can be attached to the ligand through either a radical reaction mechanism or a nonradical reaction mechanism. One or more reactive or photoreactive centers on the reaction adduct of the bifunctional molecule can be used for further crosslinking. In some embodiments, the substituted benzophenone adduct is attached to the ligand through a functional group that is not photoreactive (for example, the amino group of 4-aminobenzophenone) and it has one photoactive group per adduct. In other embodiments, the substituted benzophenone adduct is attached to the ligand through the photoreactive ketone group and it has one reactive group (for example, the amino group of 4-aminobenzophenone) that is not photoactive. In some embodiments, the ligand comprising the radical addition moiety is crosslinked to another moiety (such as another ligand in the surface coating).

In another aspect, provided herein is a nanoparticle comprising a semiconductor nanocrystal; a surface coating over the semiconductor nanocrystal comprising ligands; and an AMP coating over the surface ligand coating comprising amphiphilic polymers, wherein an amphiphilic polymer in the AMP coating comprises a radical addition moiety and wherein the radical addition moiety has one or more functional groups. In some embodiments, the amphiphilic polymer comprising the radical addition moiety is crosslinked, for example, to a ligand that is in the surface coating, another amphiphilic polymer in the AMP coating, or both. See e.g. FIG. 5.

In some embodiments, the amphiphilic polymer comprising the radical addition moiety comprises an alkyl group; the radical addition moiety is attached to a carbon atom of the alkyl group, and the radical addition moiety has one or more reactive or photoreactive groups. In some other embodiments, the radical addition moiety is attached to the amphiphilic polymer through a functional group that is not photoreactive, and the radical addition moiety has one or more photoreactive groups. In some embodiments, the radical addition moiety comprises a reaction adduct of a bifunctional compound selected from the group of a substituted benzophenone, a substituted alkoxy, a substituted acyl, a diazo ester, an aryl azide, and a diazirine. In some further embodiments, the radical addition moiety comprises a reaction adduct of a bifunctional compound that is a substituted benzophenone. In some embodiments, the substituted benzophenone has one or more reactive substituents selected from amino, hydroxyl, halo, nitrile, mercapto, carboxyl, heterocyclic, heteroaryl, and an alkyl group, wherein the alkyl group is substituted with one or more reactive substituents selected from amino, hydroxyl, halo, nitrile, mercapto, carboxyl, heterocyclic, and heteroaryl. In some embodiments, the substituted benzophenone is selected from 4-aminobenzophenone, 4-benzoylbenzoic acid, 4,4′-diaminobenzophenone, 3,3′,4,4′-benzophenone tetracarboxylic acid, 2′,3,4-benzophenone tricarboxylic acid, and 5,5′-carbonyl-bis-trimellitic acid. Where the radical addition moiety is a reaction adduct of a bifunctional molecule, the adduct can be attached to the ligand through either a radical reaction mechanism or a nonradical reaction mechanism. One or more reactive or photoreactive centers on the reaction adduct of the bifunctional molecule can be used for further crosslinking. In some embodiments, the substituted benzophenone adduct is attached to the amphiphilic polymer through a functional group that is not photoreactive (for example, the amino group of 4-aminobenzophenone) and it has one photoactive group. In other embodiments, the substituted benzophenone adduct is attached to the amphiphilic polymer through the photoreactive carbonyl group and it has one reactive group (for example, the amino group of 4-aminobenzophenone) that is not photoactive.

In another aspect, provided herein is a nanoparticle comprising a ligand having an acylaminobenzophenone as a substituent. The acylaminobenzophenone is the product of reaction between an aminobenzophenone and a carboxylic acid on the ligand, which reaction could occur either before or after the ligand becomes bound to the nanocrystal. In one embodiment, the acylaminobenzophenone is formed between an aminobenzophenone, such as 4-aminobenzophenone, and a carboxylate group on a ligand such as a dipeptide ligand on a nanocrystal.

In another aspect, provided herein is a nanoparticle comprising a semiconductor nanocrystal, a surface coating over the nanocrystal comprising ligands, and an AMP coating over the surface ligand coating wherein the AMP coating comprises an amphiphilic polymer, and wherein an amphiphilic polymer in the AMP coating has an acylaminobenzophenone as a substituent. In such embodiments, the amphiphilic polymer stably binds to the nanocrystal by interaction of hydrophobic domains of the amphiphilic polymer with the hydrophobic ligands that are directly bound to the nanocrystal inorganic surface.

In another aspect, provided herein is a method for crosslinking ligands on the surface of a nanocrystal, by irradiation of a nanoparticle with a ligand substituted by at least one acylaminobenzophenone, under conditions where the benzophenone portion forms a ketyl radical that crosslinks the ligand with another ligand on the surface of the nanocrystal.

In another aspect, provided herein is a stabilized nanoparticle comprising a first ligand that has a substituted benzophenone adduct. This ligand can be directly coordinated to the surface of the shell of a nanocrystal, and can comprise branched or unbranched alkyl chains comprising a total of up to 40 carbon atoms per ligand. In some embodiments, the first ligand is a substituted polyacrylic acid, which may be directly on the surface of the nanocrystal. In some embodiments, the first ligand is a substituted polyacrylic acid directly bound to the inorganic surface of the nanocrystal and in direct contact with the surface of the nanocrystal.

For purposes of the disclosed methods and compositions, the substituted benzophenone adduct may be substituted on a phenyl ring of the benzophenone with one or more substituents selected from amino, hydroxyl, halo, nitrile, mercapto, carboxyl, heterocyclic, heteroaryl, and an alkyl substituted with one or more of the following groups: amino, hydroxyl, halo, nitrile, mercapto, carboxyl, heterocyclic, and heteroaryl. In some embodiments, at least one substituent on the substituted benzophenone moiety is a water-solubilizing group. In some embodiments, the substituted benzophenone adduct is formed from an aminobenzophenone or a halobenzophenone, such as a benzophenone that comprises a 4-amino group.

In another aspect of the described methods and compositions, substituted benzophenones are used to crosslink nanocrystal ligands. They provide a method to make a bridged ligand for a nanocrystal, comprising using a radical reaction to add a reactant group to a first ligand attached to a nanocrystal, and using the reactant group to form a covalent bond to a second ligand on the nanocrystal. Bridged ligands comprise two nanocrystal-binding groups (e.g., phosphonate, carboxylate, phosphine, phosphine oxide, amine), one from each of the two ligands that were bonded together, and two organic groups, since each of the nanocrystal binding groups has at least one organic group. The two organic groups are connected together through a functional group that was introduced using the radical chemistry described herein. The bridged ligand increases the stability of the nanoparticle.

A substituted benzophenone for crosslinking can be attached to a ligand of the nanocrystal photochemically, using photolysis to generate a ketyl radical species from the benzophenone in solution. The ketyl radical inserts into a C—H bond, typically, of whatever hydrocarbon-containing molecules it encounters; thus photolysis of a substituted benzophenone in the presence of a ligand-coated nanocrystal causes some of the ketyl radical to react with and become attached to ligands that are on the nanocrystal, since the ligands are solvent-exposed. See FIG. 1. This produces a benzophenone adduct where the reactive keto carbon of the benzophenone is covalently linked to a carbon of the ligand. This photochemical linking of the benzophenone carbonyl to a ligand without using a functional group of the ligand is referred to herein as grafting, and can be used to functionalize and cross-link virtually any ligand. The grafted group is referred to as a benzophenone moiety or a benzophenone adduct for convenience, even though it is actually a diphenylmethanol once it is attached to the ligand.

Alternatively, the benzophenone can be attached to the ligand by nonradical reactions, such as by an amide bond-forming reaction between an amine on the benzophenone and a carboxylate on the ligand, or between a carboxylate on the benzophenone and an amine on the ligand; and crosslinking can be achieved by irradiation of the nanoparticle after the benzophenone is covalently attached.

Methods for stabilizing a nanoparticle include self-assembly of the photoreactive polymer onto a hydrophobic nanocrystal by any suitable method including, for example, methods described in Wu et al. Nat. Biotechnol. 21:41-46 (2003). Examples of semiconductor nanocrystals and nanoparticles suitable for use in the crosslinking methods of this disclosure include those disclosed in, for example, U.S. Pat. Nos. 6,322,901, 6,607,829, 6,861,155, 7,125,605, 7,374,824, and 7,390,568, which are hereby incorporated by reference in their entireties. In particular embodiments, the nanocrystal suitable for use in the crosslinking methods of this disclosure is a core/shell nanocrystal that is coated with hydrophobic ligands such as trioctylphosphine oxide (TOPO), tetradecylphosphonic acid (TDPA), trioctyl phosphine (TOP), or a mixture of such ligands. These or other hydrophobic ligands may have one or more medium- or long-chain alkyl groups having 6, 7, 8, 9, 10, 11, 12, 13, 14, 15, 16, 17, 18, 19, 20, 21, 22 or more carbon atoms. The photoreactive polymer of various embodiments can be hydrophilic or hydrophobic, and the polymer can contain one or more type of photoreactive group. Examples of photoreactive groups that may be used on the polymer include substituted benzophenones, diazo esters, aryl azides, and diazirines. In some embodiments, a substituted benzophenone such as 4-aminobenzophenone may be used where the amino group is used to attach the benzophenone to the polymer.

In certain embodiments, the nanocrystal suitable for use in the crosslinking methods of this disclosure has an amphiphilic layer. For example, hydrophilic nanoparticles are described in Adams et al. U.S. Pat. No. 6,649,138, which is hereby incorporated by reference in its entirety. In the examples of Adams et al., a hydrophobic nanoparticle has an additional layer/coating (over the surface ligand coating) comprising a molecule that has a hydrophobic domain, plus polar groups. The hydrophobic domain associates with the hydrophobic surface of the nanoparticle through hydrophobic-hydrophobic interactions, leaving the polar groups exposed to solvent. The polar groups then make the overall composition water soluble. The preferred additional layer described in Adams et al. is an amphiphilic polymer (AMP), comprising medium- to long-chain alkyl groups to provide the hydrophobic domain, and carboxylate groups to provide water solubility.

These AMP-containing compositions can benefit from crosslinking, like many other coatings on a nanocrystal: crosslinking tends to make the overall composition more stable. For these compositions that rely upon hydrophobic-hydrophobic interactions to stabilize the various coatings on the particle, crosslinking methods provided herein can also be used to link the ligands on the surface of the nanocrystal (e.g., ligands like TOPO, TOP, TDPA, oleic acid, and the like) to AMP molecules. See e.g. FIG. 5.

The disclosed methods can be used to crosslink AMP polymeric groups on a coated nanoparticle, either to each other or to other ligands of the nanoparticle. If the functionalized group (e.g., substituted benzophenone) introduced by the radical reactions described herein has an amine group on it, the amine can be connected to a carboxylate of the AMP, for example. See e.g. FIG. 5.

As an example, irradiation of a substituted benzophenone while it is in contact with the AMP-coated nanocrystal, either before or after it is linked to the carboxylate of the AMP, causes it to insert into an accessible C—H bond. If the substituted benzophenone was already connected to the AMP ligand before it was photochemically grafted onto a ligand, the result is two points of attachment of the substituted benzophenone to two different ligands, connecting the ligands together. This connection can link two AMP molecules together to provide crosslinking of the surface coating of the nanoparticle; or it can link an AMP molecule to a ligand on the nanocrystal surface, to better anchor the AMP onto the ligand coating of the nanocrystal. See e.g. FIG. 5.

In some embodiments, the nanoparticle suitable for use in the crosslinking methods of this disclosure is a QDOT™ nanocrystal (INVITROGEN). QDOT™ nanocrystals are nanometer-scale atom clusters comprising a core, shell, and coating. The core is made up of a few hundred to a few thousand atoms of a semiconductor material, for example, cadmium mixed with selenium or tellurium. A semiconductor shell, for example, zinc sulfide, surrounds and stabilizes the core, improving both the optical and physical properties of the material, and a organic ligand layer coordinates with the shell forming an organic layer around the core/shell nanoparticle. An amphiphilic polymer coating then encases this core and shell, providing a water-soluble surface that may be differentially modified to create QDOT™ nanocrystals that meet specific assay requirements. The amphiphilic coating may be covalently modified with a functionalized polyethylene glycol (PEG) outer coating. The PEG surface may reduce nonspecific binding in flow cytometry and imaging assays, thereby improving signal-to-noise ratios and providing clearer resolution of cell populations and cellular morphology. QDOT™ primary and secondary antibody conjugates, QDOT™ streptavidin conjugates, QTRACKER™ non-targeted quantum dots, and QDOT ITK™ amino (PEG) quantum dots, as well as the reactive nanocrystals provided in the QDOT™ Antibody Conjugation Kit (Invitrogen), utilize this PEG chemistry.

Examples of semiconductor nanocrystals and nanoparticles suitable for use in the crosslinking methods of this disclosure include those disclosed in, for example, U.S. Pat. Publication Nos. 2006/0202167, 2006/0001119, and 2007/0289491.

In some embodiments, the nanoparticle suitable for use in the methods of this disclosure is a water-stable semiconductor nanocrystal complex having a semiconductor nanocrystal composition of a III-V semiconductor nanocrystal core, a surface layer/coating including molecules having a moiety with an affinity for the semiconductor nanocrystal composition and a moiety with an affinity for a hydrophobic solvent, and a water-stabilizing layer/coating having a hydrophobic portion for interacting with the surface ligand layer and also a hydrophilic portion. The luminescent quantum yield of the nanoparticle may be at least 25%. The nanocrystal composition or nanoparticle may also have a shell overlaying the inorganic core. The shell may include a semiconductor material having a bulk bandgap energy greater than that of semiconductor nanocrystal core. An inorganic layer may act to passivate the outer surface of the semiconductor nanocrystal core, as well as to prevent or decrease lattice mismatch between the semiconductor nanocrystal core and shell.

In some embodiments, a stable semiconductor nanocrystal complex may include a semiconductor nanocrystal core III-V semiconductor material. The semiconductor nanocrystal core may have an outer surface and the semiconductor nanocrystal complex may have a metal layer formed on the outer surface of the semiconductor nanocrystal core, and a shell comprising a semiconductor material overcoating the metal layer. The semiconductor nanocrystal core may have a second metal layer overcoating an anion layer.

In some embodiments, the semiconductor nanocrystal core may be InP or InGaP. The semiconductor nanocrystal core/shell may be InP/ZnS.

Examples of semiconductor nanocrystals and nanoparticles suitable for use in the crosslinking methods of this disclosure include those disclosed in, for example, U.S. Pat. Nos. 6,955,855; 7,198,847; 7,205,048; 7,214,428; and 7,368,086, each of which is hereby incorporated by reference in its entirety.

The methods in some embodiments can be applied to nanoparticles or nanocrystals having hydrophilic surface ligands such as dipeptides or tripeptides. In some embodiments, the nanoparticle is a nanocrystal having a surface layer of hydrophilic ligands such as dipeptides that comprise a thiol or imidazole, and thus bind tightly to the nanocrystal surface. Examples of dipeptides include those having at least one cysteine or at least one histidine residue.

In some embodiments, a nanoparticle suitable for use in the crosslinking methods of this disclosure is a functionalized fluorescent core/shell nanocrystal having a coating material, where the coating material is histidine-based. The fluorescent nanocrystals may be coated with at least one material. The coating material has chemical compounds or ligands with functional groups or moieties with conjugated electrons and moieties for imparting high luminescence efficiency and solubility to coated fluorescent nanocrystals in aqueous solutions. The coating material provides for functionalized fluorescent nanocrystal compositions which are water soluble, chemically stable, and emit light with a quantum yield of greater than 10% and preferably greater than 50% when excited with light. The coating material may also have chemical compounds or ligands with moieties for bonding to target molecules and cells as well as moieties for crosslinking the coating. In the presence of reagents suitable for reacting to form capping layers, the compounds in the coating may form a capping layer on the fluorescent nanocrystal with the coating compounds operably bonded to the capping layer.

In some embodiments, the functionalized fluorescent nanocrystals are coated with a material comprised of a heteroaromatic compound or ligand with functional groups or moieties for imparting solubility to coated fluorescent nanocrystals in aqueous solutions. The coating material provides for functionalized fluorescent nanocrystal compositions which are water soluble, chemically stable, and emit light with high efficiency with a quantum yield of greater 10% and preferably greater than 50% upon excitation. Depending upon the ligands comprising the material coating the fluorescent nanocrystals, the functionalized fluorescent nanocrystals in some embodiments may be soluble in other liquids, for example water and isopropyl alcohol mixture or liquids with surface tensions below about 80 dynes/cm, and preferably in the range from about 30-72 dynes/cm. The coating material may also have chemical compounds or ligands including isocyanates, alkyl cyanoacrylates, or alkyl phosphines with moieties for bonding to target molecules and cells as well as moieties for crosslinking the coating according to the methods of this disclosure. In the presence of suitable reagents, for example, ZnSO₄ and Na₂S, the compounds in the coating may form a capping layer on the fluorescent nanocrystal with the coating compounds operably bonded to the capping layer.

In some embodiments, the fluorescent nanocrystal composition is a core fluorescent nanocrystal coated with an imidazole-containing compound crosslinked with an hydroxyalkyl phosphine-containing compound and complexed (e.g., by adduct formation) with an inorganic semiconductor capping layer.

In some embodiments, the nanocrystal suitable for use in the methods of this disclosure is a fluorescent nanocrystal having an imidazole-containing capping layer, wherein the capping layer includes a phosphine crosslinking compound. The functionalized, fluorescent nanocrystals or nanoparticles may avoid use of an organic solvent or mercapto-based compounds as a coating or linking agent such as for a passivation and/or as a capping compound. A coating comprising an imidazole-containing compound crosslinked with a phosphine crosslinking compound may also stabilize the outer surface of a nanocrystal. The nanocrystals may be functionalized to be water-soluble and to contain one or more reactive functionalities to which a molecular probe may be operably bound.

In some embodiments, the nanoparticle suitable for use in the methods of this disclosure is coated with a metal cation, preferably capable of forming a semiconductor material, preferably, with a high band gap energy, operably bound to an imidazole-containing compound alone or an imidazole-containing compound cross-linked with an hydroxyalkyl phosphine-containing compound, wherein the coating may be uniformly deposited over the inorganic surface of the core/shell nanocrystal. A fluorescent nanocrystal may be coated with imidazole-containing compound alone or an imidazole-containing compound cross-linked with phosphine-based crosslinking compound, to produce the functionalized, fluorescent nanocrystals. In some embodiments, onto the inorganic surface of a core/shell nanocrystal is deposited a coating comprising imidazole-containing compound alone or an imidazole-containing compound and alkyl phosphine-containing compound. A functionalized, fluorescent nanocrystal may include chemical or physical crosslinking of the coating having an imidazole containing compound, and alternatively, an imidazole-containing compound and alkyl phosphine-containing compound, to promote further stabilization of the coat of the functionalized, fluorescent nanocrystal.

Crosslinking can be achieved by using the methods and reagents as described herein.

Crosslinking can be achieved by using other methods and reagents known in the art which include formaldehyde, glutaraldehyde, acrolein, 1,6-hexane-bis-vinylsulfone and the like.

### Conjugates and Properties

A nanoparticle conjugate can be formed by linking a nanoparticle to another moiety. The other moiety can be an affinity molecule, such as an antibody, receptor or enzyme, which specifically recognizes, binds to or modifies another compound or structure. The nanoparticle conjugate, by virtue of the affinity molecule, can be used to detect, for example, the presence and/or quantity of biological and chemical compounds, interactions in biological systems, biological processes, alterations in biological processes, or alterations in the structure of biological compounds. The affinity molecule, when linked to the semiconductor nanoparticle, can interact with a biological target that serves as the second member of the binding pair, in order to detect biological processes or reactions, or to alter biological molecules or processes. The interaction of the affinity molecule and the biological target may involve specific binding, and can involve covalent, noncovalent, hydrophobic, hydrophilic, electrostatic, van der Waals, magnetic, or other interactions.

The affinity molecule associated with a nanoparticle can be naturally occurring or chemically synthesized, and can be selected to have a desired physical, chemical or biological property. Such properties include covalent and noncovalent association with, for example, signaling molecules, prokaryotic or eukaryotic cells, viruses, subcellular organelles and any other biological compounds or physiological structures such as tumors. Other properties include the ability to affect a biological process, cell cycle, blood coagulation, cell death, transcription, translation, signal transduction, DNA damage or cleavage, production of radicals, scavenging radicals, the ability to alter the structure of a biological compound, crosslinking, proteolytic cleavage, and radical damage.

In some embodiments, a nanoparticle may be conjugated to a molecule or species for detection by means of FRET. In some embodiments, the FRET efficiency in a FRET reaction of the nanoparticles in some embodiments can be at least 25%, at least 40%, at least 50%, at least 60%, at least 70%, at least 80%, at least 90%, or greater up to 100%.

FRET refers to Förster Resonance Energy Transfer which is the basis of various fluorescence-based measurement techniques that allow detection of the proximity of two appropriately labeled molecules or species. In FRET, a donor label non-radiatively transfers energy to a second acceptor label. The acceptor may be a fluorophore which may then emit a photon. Donor-acceptor pairs are selected such that there is overlap between the emission spectrum of the donor and excitation spectrum of the acceptor. In some applications, the acceptor may be a dark or non-emitting quencher.

FRET efficiency depends sharply on donor-acceptor distance r as 1/r⁶. The distance where FRET efficiency is 50% is termed R₀, also known as the Förster distance. R₀ is unique for each donor-acceptor combination and may be 5 to 10 nm. In biological applications, FRET can provide an on-off type of signal, indicating when the donor and acceptor are within R₀ of each other. Additional factors affecting FRET efficiency include the quantum yield of the donor, the extinction coefficient of the acceptor, and the degree of spectral overlap between donor and acceptor. FRET efficiency and signal detection is described in D. W. Piston and G. J. Kremers, Trends Biochem. Sci. 32:407 (2007). Nanocrystals have been used for FRET detection in biological systems. See, e.g., Willard et al., 2001, Nano. Lett. 1:469; Patolsky F et al., 2003, J. Am. Chem. Soc. 125:13918; Medintz I. L. et al., 2003, Nat. Mater. 2:630; Zhang C. Y., et al., 2005, Nat. Matter. 4:826. Nanocrystals may be advantageous because their emission may be size-tuned to improve spectral overlap with an acceptor or quencher. Nanocrystals in general have high quantum yield and are less susceptible to photobleaching than other FRET donors.

### DESCRIPTION OF EMBODIMENTS

Various embodiments are directed to a method for preparing a functionalized nanoparticle including the steps of generating a radical species on at least one functional group of a first reagent and reacting the radical species on the at least one functional group of the first reagent at least one carbon of the aliphatic chain containing surface ligand by a radical reaction to form a covalent bond between the aliphatic chain containing surface ligand and the first reagent to produce a functionalized surface ligand. In some embodiments, the first reagent may include at least one functional group selected from carbonyl, diazine, azide, and peroxide, and in other embodiments, the first reagent may include a radical forming agent selected from alkyl diazine, diazo ester, aryl azide, diazirine, substituted or unsubstituted benzophenone, acyl phosphine oxide, substituted or unsubstituted peroxide, and substituted or unsubstituted benzoylperoxide. In certain embodiments, the at least one functional group of the first reagent may include a photoreactive functional group, and generating a radical species may include irradiating the first reagent. In some embodiments, the at least one functional group of the first reagent may include a thermoreactive functional group and generating a radical species may include heating the first reagent. In particular embodiments, generating a radical species on at least one functional group of a first reagent may include generating a diradical on at least one functional group of the first reagent, and in some embodiments, the diradical on the at least one functional group of the first reagent extracts a hydrogen from an alkyl of the aliphatic chain containing surface ligand bound to the nanoparticle to generate an alkyl radical on at least one carbon of an aliphatic.

In other embodimets, the first reagent may include at least one second functional group that is capable of forming a covalent bond without a radical reaction, and in some such embodiments, the at least one second functional group may be halogen, amino, hydroxy, alkoxy, carboxy, nitrile, thiol, alkene, alkyne, azide, succinimide, or maleimide. In particular embodiments, the at least one second functional group can impart water dispersibility on the nanoparticle. In some embodiments, the method may include crosslinking the functionalized ligand to a second functionalized ligand by reacting the at least one second functional group with at least one functional group on the second functionalized ligand to produce a crosslinked functionalized nanoparticle. In certain embodiments, the first reagent may be a substituted benzophenone or an aminobenzophenone, and in particular embodiments, the first reagent may be 4-aminobenzophenone, 4-benzoylbenzoic acid, 4,4′-diaminobenzophenone, 3,3′,4,4′-benzophenone tetracarboxylic acid, 2′,3,4-benzophenone tricarboxylic acid, 5,5′-carbonyl-bis-trimellitic acid, and 4-aminobenzophenone, or 4,4′-diaminobenzophenone.

In some embodiments, the method may include reacting the functionalized ligand with at least one second reagent having one or more functional groups, and in particular embodiments, such methods may include the step of reacting at least one of the one or more functional groups of the at least one second reagent with a functional group on a second functionalized ligand to produce a crosslinked functionalized nanoparticle. In some embodiments, the at least one second reagent may be dicarboxylic acid, glutaric acid, carbodiimide (CDI), diamine, ethylene diamine, a reagent of formula H₂N—(CH₂)ₓ—NH₂ wherein x is 2-6, tris(hydroxymethyl)phosphine (THP), or tris(hydroxymethyl)phosphonium propionate (THPP).

The method of certain embodiments may include generating an alkyl radical on at least one carbon of an aliphatic chain containing surface ligand bound to the nanoparticle, and in some embodiments, the aliphatic chain containing surface ligand bound to the nanoparticle at least comprises a C₁-C₄₀ aliphatic hydrocarbon, and a nanoparticle binding center selected from phosphonic acid, phosphine, phosphine oxide, carboxylate, thiol, and imidazole.

Some embodiments are directed to a method for preparing a functionalized nanoparticle including the steps of generating a halogen radical on at least one carbon of an aliphatic chain containing surface ligand bound to the nanoparticle to form at least one halogenated ligand, and performing a nucleophilic substitution between the halogen radical of the halogenated ligand and a functional group of at least one first reagent to produce a functionalized nanoparticle. In some embodiments, the step of generating a halogen radical on at least one carbon of an aliphatic chain containing surface ligand bound to the nanoparticle further include combining nanoparticles having a aliphatic chain containing surface ligands coating with a halogenating reagent and halogenating at least one carbon of an aliphatic chain containing surface ligand bound to the nanoparticle. In such embodiments, the halogenating reagent may be N-bromosuccinimide (NBS) and N-chlorosuccinimide (NCS), tribromide salt, phenyl trimethylammonium tribromide, and combinations thereof. In other embodiments, the functional group of the at least one first reagent may be thiol, azide, and combinations thereof. In still other embodiments, the method may further include crosslinking at least two halogenated ligands using at least one first reagent comprising two or more functional groups capable of performing a nucleophilic substitution, and in some embodiments, the at least one first reagent can be cys-cys. In yet other embodiments, the at least one first reagent may include at least one second functional group that imparts water-solubility on the nanoparticle, and in some embodiments, the at least one second functional group may be amino, hydroxy, alkoxy, carboxy, nitrile, thiol, alkene, alkyne, azide, succinimide, and maleimide.

Other embodiments include a method for preparing a functionalized nanoparticle including the steps of generating a halogen radical on at least one carbon of an aliphatic chain containing surface ligand bound to the nanoparticle to form at least one halogenated ligand and replacing the halogen radical of the halogenated ligand with a functional group to produce a functionalized ligand. In some embodiments, the step of generating a halogen radical on at least one carbon of an aliphatic chain containing surface ligand bound to the nanoparticle may include combining nanoparticles having a aliphatic chain containing surface ligands coating with a halogenating reagent and halogenating at least one carbon of an aliphatic chain containing surface ligand bound to the nanoparticle, and in such embodiments, the halogenating reagent may be N-bromosuccinimide (NBS) and N-chlorosuccinimide (NCS), tribromide salt, phenyl trimethylammonium tribromide, and combinations thereof. In some embodiments, the functional group of the functionalized ligand can be azide and thiol, and in particular embodiments, the method may include converting an azide functional group into an amino functional group. In some embodiments, the method may further include reacting the functionalized ligand with at least one first reagent having at least one functional group capable of reacting with the amino functional group of the functionalized ligand, and in other embodiments, the method may further include reacting a second functionalized ligand with the at least one first reagent thereby crosslinking at least two functionalized ligands having amino functional groups bound to the nanoparticle. In such embodiments, the at least one first reagent can be dicarboxylic acid, glutaric acid, carbodiimide (CDI), tris(hydroxymethyl)phosphine (THP), and tris(hydroxymethyl)phosphonium propionate (THPP). In other embodiments, the functional group of the functionalized ligand can be azide and the at least one first reagent can be one or more alkyne. In some such embodiments, the at least one first reagent can be a compound of the formula HC≡(CH₂)ₜC≡CH, where t is 1, 2, 3, 4, or 5. In other such embodiments, the method may include reacting a second functionalized ligand with the at least one first reagent thereby crosslinking at least two functionalized ligands having azide functional groups bound to the nanoparticle.

Still other embodiments are directed to a method for making a functionalized nanoparticle including combining one or more nanoparticles having a coating of aliphatic chain containing ligands and an amphiphilic polymer having one or more functional groups capable of forming a radical species to create a mixture, generating a radical species on the one or more functional groups of the amphiphilic polymer, and reacting the radical species on the one or more functional groups of the amphiphilic polymer with at least one carbon of the aliphatic chain containing ligand by radical reaction to form a covalent bond between the aliphatic chain containing ligand and the amphiphilic polymer thereby crosslinking the amphiphilic polymer to the nanoparticle. In some embodiments, the method may further include generating an alkyl radical on at least one carbon of the aliphatic chain containing ligands bound to the nanoparticle. In other embodiments, the amphiphilic polymer can be a substituted polyacrylic acid, and in still other embodiments, the amphiphilic polymer can include at least one functional such as carbonyl, diazine, azide, peroxide, and combinations thereof. In particular embodiments, the amphiphilic polymer can include a radical forming agent selected from alkyl diazine, diazo ester, aryl azide, diazirine, substituted or unsubstituted benzophenone, acyl phosphine oxide, substituted or unsubstituted peroxide, and substituted or unsubstituted benzoylperoxide, and in some embodiments, the at least one functional group of the amphiphilic polymer may include carboxylic acid groups of a polyacrylic acid attached to an aminobenzophenone or 4-aminobenzophenone. In certain embodiments, the at least one functional group of the amphiphilic polymer can be a photoreactive functional group, and generating a radical species can include irradiating the mixture. In other embodiments, the at least one functional group of the amphiphilic polymer may be a thermoreactive functional group, and generating a radical species can include heating the mixture. In some embodiments, generating a radical species on at least one functional group of an amphiphilic polymer can include generating a diradical on the at least one functional group of the amphiphilic polymer. In other embodiments, the method may include binding the amphiphilic polymer to the aliphatic chain containing ligands bound to the nanoparticle through interactions include, but not limited to, hydrogen bonds, covalent bonds between one or more of the plurality of functional groups of the amphiphilic polymer and functional groups attached to the plurality of aliphatic chain containing ligands bound to the nanoparticle, covalent bonds between a radical forming functional group on an alkyl of an aliphatic chain containing ligand bound to the nanoparticle and the amphiphilic polymer, and combinations thereof. In certain embodiments, the method can further include crosslinking the amphiphilic polymer to one or more other amphiphilic polymers.

Yet other embodiments are directed to a functionalized nanoparticle prepared by the method including generating a radical species on at least one first functional group of a first reagent wherein the first reagent further comprises at least one second functional group selected from nitrile, thiol, alkene, alkyne, azide, succinimide, and maleimide and reacting the radical species on the at least one functional group of the first reagent with at least one carbon of the aliphatic chain containing surface ligand to form a covalent bond between the aliphatic chain containing surface ligand and the first reagent to produce a functionalized surface ligand by a radical reaction between. In some embodiments, the method can further include generating an alkyl radical on at least one carbon of an aliphatic chain containing surface ligand bound to the nanoparticle. In other embodiments, at least one second functional group of the at least one first reagent can impart water-solubility on the nanoparticle.

Still other embodiments are directed to a functionalized nanoparticle prepared by the method including generating a halogen radical on at least one carbon of an aliphatic chain containing surface ligand bound to the nanoparticle to form at least one halogenated ligand and replacing the halogen radical of the halogenated ligand with a functional group selected from nitrile, thiol, alkene, alkyne, azide, succinimide, and maleimide to produce a functionalized ligand. In some embodiments, the functional group replacing the halogen radical can impart water-solubility on the nanoparticle.

Still further embodiments are directed to a functionalized nanoparticle prepared by the method including generating a halogen radical on at least one carbon of an aliphatic chain containing surface ligand bound to the nanoparticle to form at least one halogenated ligand and performing a nucleophilic substitution between the halogen radical of the halogenated ligand and a functional group of at least one first reagent to produce a functionalized nanoparticle where the first reagent further comprises at least one second functional group selected from nitrile, thiol, alkene, alkyne, azide, succinimide, and maleimide. In some embodiments, at least one second functional group of the at least one first reagent imparts water-solubility on the nanoparticle.

### EXAMPLES

The following examples are offered to illustrate but not to limit the embodiments disclosed herein.

### Example 1

Functionalization of Octylphosphine Oxide Coated Nanoparticles with 4-aminobenzophenone and THPP Crosslinking:

Trisoctylphosphine oxide coated CdSe nanocrystals prepared according to Example 1 of U.S. Pat. No. 6,322,901 without surface exchange are added to a solution of 4-aminobenzophenone in hexanes or carbon tetrachloride and stirred until dispersed. The solution is exposed to sufficient ultraviolet irradiation to generate 4-aminobenzophenone radicals at ambient temperature. The resultant solution is concentrated to a few mL by evaporation, then the nanocrystals are precipitated and isolated.

The nanocrystals are dispersed in chloroform, and crosslinked using tris(hydroxymethyl)phosphinopropionic acid (THPP) under the conditions described in U.S. Pat. No. 7,198,847, which includes treating ca. 1-3 mg sample of nanocrystals in about 100 microliters of chloroform with 1.2 mL of THPP at room temperature for an hour, then adding 100 microliters of 1M putrescine, and stiffing for another hour. The additions of THPP and putrescine are then repeated three more times to promote extensive crosslinking of the benzophenone adduct ligands. The crosslinked nanoparticles are isolated, and exhibit improved stability relative to non-crosslinked nanoparticles.

### Example 2

Functionalization of TOPO/TOP Coated Nanopartilces with 4-aminobenzophenone:

AMP-coated TOPO/TOP coated CdSe/ZnS core/shell nanocrystals prepared according to Examples 1-2 of U.S. Pat. No. 6,649,138 are dispersed in a solution of 4-aminobenzophenone in chloroform or carbon tetrachloride. The solution is exposed to sufficient ultraviolet irradiation to generate 4-aminobenzophenone radicals at ambient temperature. The resultant solution is concentrated to a few mL by evaporation, then the nanocrystals are precipitated and isolated.

### Example 3

Functionalization of Histidine Ligand Coated Nanoparticles with 4-aminobenzophenone:

Histidine-containing molecules-coated CdSe/ZnS core/shell nanocrystals prepared according to Example 1 of U.S. Pat. No. 6,955,855 are dispersed in a solution of 4-aminobenzophenone in chloroform. The solution is exposed to sufficient ultraviolet irradiation to generate 4-aminobenzophenone radicals at ambient temperature. The resultant solution is concentrated to a few mL by evaporation, then the nanocrystals are precipitated and isolated.

### Example 4

Functionalization and Crosslinking of AMP Coated Nanoparticles with 4,4′-diaminobenzophenone:

Nanocrystals having an AMP coating are dispersed in boric buffer solvent containing 4,4′-diaminobenzophenone, and exposed to UV light for one hour with stiffing. The coated, crosslinked nanocrystals are isolated.

### Example 5

### Preparation of Covalently Bonded Amphiphilic Polymer Coated Nanoparticles

A photocrosslinkable amphiphilic AMP polymer was prepared by coupling a fraction of the carboxylic acid groups of a polyacrylic acid with octylamine and 4-aminobenzophenone using 1-ethyl-3-(3-dimethylaminopropyl)carbodiimide (EDC). Polymer-coated water-soluble nanoparticles were prepared by assembling the AMP polymer with a core/shell CdSe/ZnS nanocrystal of the type used to make QDOT™ 655.

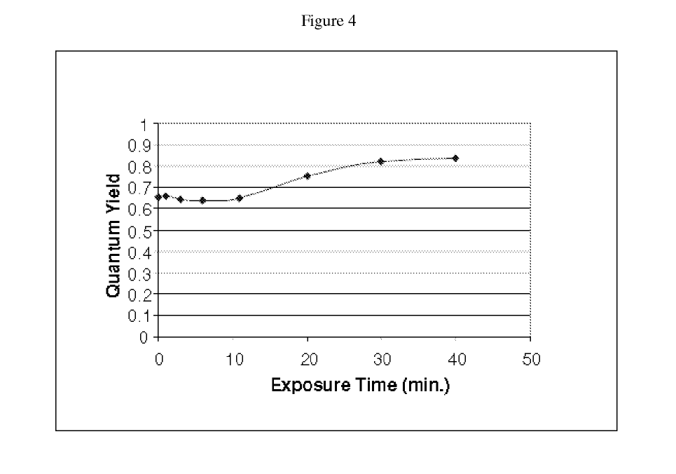

The polymer-coated water-soluble nanoparticles were exposed to ultraviolet (UV) irradiation. FIG. 4 shows the quantum yield of the nanoparticles upon exposure to UV light. The quantum yield of the photolyzed nanoparticles increased significantly under UV exposure for about twenty to forty minutes. The enhanced quantum yield of the photolyzed nanoparticles was preserved after storage for three weeks.

### Example 6

Functionalization and Crosslinking of Octylphosphine Oxide Coated Nanoparticles with 4-aminobenzophenone and THP:

Trisoctylphosphine oxide coated CdSe nanocrystals prepared according to Example 1 of U.S. Pat. No. 6,322,901 without surface exchange are dispersed in water using a mixture of histidine-containing dipeptides. After photochemically linking 4-aminobenzophenone to the surface of the nanoparticles, a solution of tris(hydroxymethyl)phosphine (THP) dissolved in DMSO is added to the mixture. The solution is stirred at room temperature for at least 12 hours before purification.

Various modifications of the embodiments, in addition to those described herein, will be apparent to those skilled in the art from the foregoing description. Such modifications are also intended to fall within the scope of the appended claims. Each reference cited in the present application is herein incorporated by reference in its entirety.

1. A method for preparing a functionalized nanoparticle comprising:
generating a radical species on at least one functional group of a first reagent; and
reacting the radical species on the at least one functional group of the first reagent at least one carbon of the aliphatic chain containing surface ligand by a radical reaction to form a covalent bond between the aliphatic chain containing surface ligand and the first reagent to produce a functionalized surface ligand.

2. The method of claim 1, wherein the first reagent comprises at least one functional group selected from carbonyl, diazine, azide, and peroxide.

3. The method of claim 1, wherein the first reagent comprises a radical forming agent selected from alkyl diazine, diazo ester, aryl azide, diazirine, substituted or unsubstituted benzophenone, acyl phosphine oxide, substituted or unsubstituted peroxide, and substituted or unsubstituted benzoylperoxide.

4. The method of claim 1, wherein the at least one functional group of the first reagent comprises a photoreactive functional group, and generating a radical species comprises irradiating the first reagent.

5.-7. (canceled)

8. The method of claim 1, wherein the first reagent comprises at least one second functional group that is capable of forming a covalent bond without a radical reaction.

9. The method of claim 8, wherein the at least one second functional group is selected from halogen, amino, hydroxy, alkoxy, carboxy, nitrile, thiol, alkene, alkyne, azide, succinimide, and maleimide.

10. The method of claim 8, wherein the at least one second functional group imparts water dispersibility on the nanoparticle.

11. The method of claim 8, further comprising crosslinking the functionalized ligand to a second functionalized ligand by reacting the at least one second functional group with at least one functional group on the second functionalized ligand to produce a crosslinked functionalized nanoparticle.

12. The method of claim 8, wherein the first reagent is a substituted benzophenone or an aminobenzophenone.

13. The method of claim 8, wherein the first reagent is selected from 4-aminobenzophenone, 4-benzoylbenzoic acid, 4,4′-diaminobenzophenone, 3,3′,4,4′-benzophenone tetracarboxylic acid, 2′,3,4-benzophenone tricarboxylic acid, and 5,5′-carbonyl-bis-trimellitic acid.

14. The method of claim 8, further comprising reacting the functionalized ligand with at least one second reagent having one or more functional groups.

15. The method of claim 14, further comprising reacting at least one of the one or more functional groups of the at least one second reagent with a functional group on a second functionalized ligand to produce a crosslinked functionalized nanoparticle.

16. The method of claim 14, wherein the at least one second reagent is selected from dicarboxylic acid, glutaric acid, carbodiimide (CDI), diamine, ethylene diamine, a reagent of formula H₂N—(CH₂)x-NH₂ wherein x is 2-6, tris(hydroxymethyl)phosphine (THP), and tris(hydroxymethyl)phosphonium propionate (THPP).

17. The method of claim 1, further comprising generating an alkyl radical on at least one carbon of an aliphatic chain containing surface ligand bound to the nanoparticle.

18. The method of claim 1, wherein the aliphatic chain containing surface ligand bound to the nanoparticle at least comprises a C₁-C₄₀ aliphatic hydrocarbon, and a nanoparticle binding center selected from phosphonic acid, phosphine, phosphine oxide, carboxylate, thiol, and imidazole.

19.-26. (canceled)

27. A method for preparing a functionalized nanoparticle comprising:
generating a halogen radical on at least one carbon of an aliphatic chain containing surface ligand bound to the nanoparticle to form at least one halogenated ligand; and
replacing the halogen radical of the halogenated ligand with a functional group to produce a functionalized ligand.

28. The method of claim 27, wherein the step of generating a halogen radical on at least one carbon of an aliphatic chain containing surface ligand bound to the nanoparticle further comprises:
combining nanoparticles having a aliphatic chain containing surface ligands coating with a halogenating reagent; and
halogenating at least one carbon of an aliphatic chain containing surface ligand bound to the nanoparticle.

29. The method of claim 28, wherein the halogenating reagent is selected from N-bromosuccinimide (NBS) and N-chlorosuccinimide (NCS), tribromide salt, phenyl trimethylammonium tribromide, and combinations thereof.

30. The method of claim 27, wherein the functional group of the functionalized ligand is selected from azide and thiol.

31. The method of claim 30, further comprising converting an azide functional group into an amino functional group.

32. The method of claim 31, further comprising reacting the functionalized ligand with at least one first reagent having at least one functional group capable of reacting with the amino functional group of the functionalized ligand.

33. The method of claim 32, further comprising reacting a second functionalized ligand with the at least one first reagent thereby crosslinking at least two functionalized ligands having amino functional groups bound to the nanoparticle.

34. The method of claim 32, wherein the at least one first reagent is selected from dicarboxylic acid, glutaric acid, carbodiimide (CDI), tris(hydroxymethyl)phosphine (THP), and tris(hydroxymethyl)phosphonium propionate (THPP).

35. The method of claim 32, wherein the functional group of the functionalized ligand is azide and the at least one first reagent comprises one or more alkyne.

36. (canceled)

37. The method of claim 36, further comprising reacting a second functionalized ligand with the at least one first reagent thereby crosslinking at least two functionalized ligands having azide functional groups bound to the nanoparticle.

38. A method for making a functionalized nanoparticle comprising:
combining one or more nanoparticles having a coating of aliphatic chain containing ligands and an amphiphilic polymer having one or more functional groups capable of forming a radical species to create a mixture;
generating a radical species on the one or more functional groups of the amphiphilic polymer; and
reacting the radical species on the one or more functional groups of the amphiphilic polymer with at least one carbon of the aliphatic chain containing ligand by radical reaction to form a covalent bond between the aliphatic chain containing ligand and the amphiphilic polymer thereby crosslinking the amphiphilic polymer to the nanoparticle.

39. The method of claim 38, further comprising generating an alkyl radical on at least one carbon of the aliphatic chain containing ligands bound to the nanoparticle.

40. The method of claim 38, wherein the amphiphilic polymer is a substituted polyacrylic acid.

41. The method of claim 38, wherein the amphiphilic polymer comprises at least one functional group selected from carbonyl, diazine, azide, peroxide, and combinations thereof.

42. The method of claim 38, wherein the amphiphilic polymer comprises a radical forming agent selected from alkyl diazine, diazo ester, aryl azide, diazirine, substituted or unsubstituted benzophenone, acyl phosphine oxide, substituted or unsubstituted peroxide, and substituted or unsubstituted benzoylperoxide.

43. The method of claim 38, wherein the at least one functional group of the amphiphilic polymer comprises carboxylic acid groups of a polyacrylic acid attached to an aminobenzophenone or 4-aminobenzophenone.

44.-47. (canceled)

48. The method of claim 38, further comprising crosslinking the amphiphilic polymer to one or more other amphiphilic polymers.

49. A functionalized nanoparticle prepared by the method comprising:
generating a radical species on at least one first functional group of a first reagent wherein the first reagent further comprises at least one second functional group selected from nitrile, thiol, alkene, alkyne, azide, succinimide, and maleimide;
reacting the radical species on the at least one functional group of the first reagent with at least one carbon of the aliphatic chain containing surface ligand to form a covalent bond between the aliphatic chain containing surface ligand and the first reagent to produce a functionalized surface ligand by a radical reaction between.

50. The functionalized nanoparticle of claim 49, wherein the method further comprises generating an alkyl radical on at least one carbon of an aliphatic chain containing surface ligand bound to the nanoparticle.

51. The functionalized nanoparticle of claim 49, wherein at least one second functional group of the at least one first reagent imparts water-solubility on the nanoparticle.

52. A functionalized nanoparticle prepared by the method comprising:
providing a nanoparticle having an aliphatic chain containing surface ligand;
generating a halogen radical on at least one carbon of an aliphatic chain containing surface ligand bound to form at least one halogenated ligand; and
replacing the halogen radical of the halogenated ligand with a functional group selected from nitrile, thiol, alkene, alkyne, azide, succinimide, and maleimide to produce a functionalized ligand.

53. The functionalized nanoparticle of claim 52, wherein the functional group replacing the halogen radical imparts water-solubility on the nanoparticle.

54.-55. (canceled)
